(19) United States
(12) Patent Application Publication
(10) Pub. No.: US 2016/0031582 A1
(43) Pub. Date: Feb. 4, 2016

(54) LABELING MACHINE

(71) Applicant: CENZ Automation Co. Ltd., Taipei City (TW)

(72) Inventors: Chyi-Yeu Lin, Taipei City (TW); Li-Te Liu, Taipei City (TW)

(21) Appl. No.: 14/813,136

(22) Filed: Jul. 30, 2015

(30) Foreign Application Priority Data
Jul. 30, 2014 (TW) 103126337
Jul. 15, 2015 (TW) 104122867

(51) Int. Cl. B65C 9/36; B65C 9/08; B65C 9/04; B65C 9/00

(52) U.S. Cl. CPC B65C 9/36; B65C 9/0006; B65C 9/08; B65C 9/04

(57) ABSTRACT

A labeling machine including a substrate, an assembling element, a carrying shaft, a driving module, a labeling module, a peeling unit and a furling shaft is provided. The assembling element is disposed at one side of the substrate allowing it to be installed onto a robot. The carrying shaft is disposed on the substrate, and a label base with multiple labels is assembled on the carrying shaft. The driving module and the labeling module are disposed on the substrate. The peeling unit, the carrying shaft and the furling shaft are all disposed at the same side of the substrate. The furling shaft controlled by the driving module is used to furl the label base. When the label base wraps around the peeling unit and the driving module drives the furling shaft to rotate, the labeling module near by the pressing unit would capture the label protruded from the label base.

### CROSS-REFERENCE TO RELATED APPLICATION

This application claims the priority benefits of Taiwan application no. 103126337, filed on Jul. 30, 2014 and Taiwan application no. 104122867, filed on Jul. 15, 2015. The entirety of each of the above-mentioned patent applications is hereby incorporated by reference herein and made a part of this specification.

### BACKGROUND OF THE INVENTION

1. Field of the Invention

The invention relates to a labeling machine, more particularly to a labeling machine which has a different structure configuration from the conventional labeling machine. The labeling machine in the invention is appropriate to install onto a robot to perform automatic labeling.

2. Description of Related Art

In the early days, the worker only uses his fingers to strip off a label on a label base and then to adhere the label on a surface of an object, such as a bottle, a PET bottle, a circuit board, or other objects which require to be labeled for identification. This manual method is not only time-consuming but also uneconomical. In order to increase efficiency of stripping the label from the label base, an electric peeling machine is developed in industry. Firstly, a roll of continuous label is disposed in the peeling machine. The peeling machine can use a rotating mechanism to separate the front end of the label from the label base. Most of the peeling machine can make the front part which is about 80% area of the label separate from the label base, so that the worker can use his fingers to take the labeling paper. Therefore, a large amount of time, which is used to separate the label and the label base manually, is reduced. However, the label is still taken from the label base and is adhered on the object by hand. The peeling machine only assists the worker to strip the label from the label base, and can not perform an action that the label is adhered on the object. In addition, there is a lack of a labeling machine, which can be held by hand to trip off the label and to adhere the label, on the market.

Another automatic labeling machine, which can automatically adhere the label on the object, is also developed, and the label base in the automatic labeling machine is driven by mechanical power. However, the automatic labeling machine in present usually has a huge volume, high manufacturing cost, and a bad alignment mechanism when the label is adhered. In addition, the automatic labeling machine in present can only be suitable to apply for regular-shaped objects, and can only adhere the label on the outermost boundary of the object. In case of continuous adhesive, there is a need to carry the objects by conveyor belt. Furthermore, using the labeling machine to perform adhering label continuously and automatically becomes a new trend, the robot and the peeling machine are used together to perform the label adhering action. An air sucking disc is disposed at the end of the robotic arm. Firstly, the robot is commanded to move the air sucking disc to the peeling machine nearby, and the air sucking disc sucks the label which is almost stripped from the label base. After that, the robot carries the air sucking disc, which has the label, to the object needed to be labeled, and applies a force forward to the object, so as to complete the labeling action. Although this method presents a highly automated process, the main disadvantage of this method is that the robot needs to move back and forth between the peeling machine and the object to perform label adhering action. Therefore, the robot cannot perform label adhering action continuously on the object, which is not only wasting time but also wasting energy. The multi-axis articulated robot, the multi-axis parallel robot, and the single axis or multi-axis linear robot are frequently used in industry.

### SUMMARY OF THE INVENTION

The invention provides a labeling machine which has a different structure configuration from that of the conventional labeling machine. The labeling machine in the invention is appropriate to install at a robot to perform automatic labeling.

A labeling machine of the invention includes a substrate, an assembling element, a carrying shaft, a driving module, a labeling module, a peeling unit and a furling shaft. The labeling machine is assembled onto a robot by the assembling element disposed at one side of the substrate. The carrying shaft is disposed on the substrate, and a label base is assembled on the carrying shaft. The driving module and the labeling module are disposed on the substrate. The peeling unit, the carrying shaft and the furling shaft are all disposed at one side of the substrate. The label base is used to furl around the furling shaft, which is controlled by the driving module. When the label base passes by the peeling unit, the driving module drives the furling shaft to rotate, the label protruded from the label base is captured by the labeling module at adjacent region of the peeling unit.

In one embodiment of the labeling machine in the invention, the labeling machine further includes a shifting device, wherein the shifting device pushes the labeling module in a direction perpendicular to a label detaching direction of the labeling module, so as to generate an overlapping area of the labeling module and the peeling unit. The shifting device includes a pneumatic cylinder and a pressing block, which is connected with the pneumatic cylinder; wherein the pneumatic cylinder applies a force to push the pressing block and drives the labeling module to move, so that the overlapping area of the labeling module and the peeling unit is generated. The shifting device further includes a spring, which the spring is disposed between the pressing block and the labeling module, and it is adapted to drive the pressing block back to an original position by an elastic restoring force when the pneumatic cylinder stops applying force.

In one embodiment of the labeling machine in the invention, the assembling element has a plurality of assembling structures, and the labeling machine and the robot are assembled together via the assembling structures, wherein the assembling structures can be assembly holes.

In one embodiment of the labeling machine in the invention, the driving module includes: a motor which is disposed on a first surface of the substrate; a pair of rotating shafts which are disposed on a second surface of the substrate, wherein the first surface and the second surface are located at two opposite surfaces of the substrate; one of the rotating shafts is connected with the motor, and another is connected with the furling shaft disposed on the second surface; a belt which wreathe around the rotating shafts, wherein the rotating shaft driven by the motor drives the rotating shaft connected with the furling shaft to rotate.

In one embodiment of the labeling machine in the invention, the driving module comprises: a motor which is disposed on the second surface of the substrate, and connected with the furling shaft disposed on the first surface of the substrate.

In one embodiment of the labeling machine in the invention, the front edge of the peeling unit is an inclined plane or an arc surface, and upwardly inclined in a direction from far from the carrying shaft to close to the carrying shaft.

In one embodiment of the labeling machine in the invention, the labeling module comprises a cylinder which is disposed on a second surface of the substrate; and a labeling unit which is connected with the cylinder, and driven by the cylinder to operate along a straight line.

In one embodiment of the labeling machine in the invention, the labeling module further comprises a positioning block which is connected to the cylinder, wherein the cylinder and the positioning block are disposed on the same side of the substrate, and the positioning block is driven by the cylinder to operate along a straight line; a driving rod which is fixed to the positioning block and passing though the substrate to connect with the labeling unit, wherein the driving rod drives the labeling unit to move along with a movement of the positioning block.

In one embodiment of the labeling machine in the invention, the labeling module further includes a pair of tracks, disposed on the second surface and disposed along two opposite sides of a breach of the substrate, and the driving rod is moved within the breach.

In one embodiment of the labeling machine in the invention, the labeling unit includes a first base which is disposed on the first surface of the substrate, connected to the driving rod, and moved along with the movement of the driving rod; a second base which fits in with the first base, wherein the second base has a top portion and a bottom portion; and a labeling head which leans against a front end of the second base, and connects to the shifting device, wherein the shifting device actuates to drive the labeling head to move in a space between the top portion and the bottom portion of the second base, so as to generate an overlapping area of the labeling module and the peeling unit.

In one embodiment of the labeling machine in the invention, the labeling unit further includes: a pair of adjusting members, wherein one of the adjusting members passes through a part of the first base and inserts into the second base, the second base moves relatively to the first base via the adjusting member, a direction of movement of the second base is perpendicular to a direction of movement of the first base driven by the driving shaft, and another one of the adjusting members passes through the first base and adjusts a position of the first base on the driving rod relatively to a position of the substrate.

In one embodiment of the labeling machine in the invention, the labeling head includes: an abutting block which connects to the shifting device and leans against the front end of the second base; a labeling block which is located in front of the abutting block; at least one pair of elastic members which are disposed between the labeling block and the abutting block.

In one embodiment of the labeling machine in the invention, the labeling module is pivotally connected to the substrate and can rotate on the first surface.

In one embodiment of the labeling machine in the invention, the labeling module further includes a positioning block which is connected to the cylinder and located at a side edge of the substrate, wherein the positioning block is adapted to be driven by the cylinder to operate along a straight line; a first base which is fixed on the positioning block; and a labeling head which is disposed at a front end of the first base.

In one embodiment of the labeling machine in the invention, the labeling head includes an abutting block which is connected to the first base; a labeling block which is located in front of the abutting block; and an elastic member which is built into the abutting block, and the elastic member provides elasticity for the labeling block.

In one embodiment of the labeling machine in the invention, the labeling machine further includes a vacuum generator and a connecting pipe, and the vacuum generator is disposed on the substrate and connected to the labeling module by the connecting pipe to make the labeling module generate suction, so as to suck the label protruded from the labeling base.

In one embodiment of the labeling machine in the invention, the labeling machine further includes a blowing member which is disposed corresponding to the labeling module and the peeling unit, and the blowing member blows the label protruded from the labeling base towards the labeling module.

In one embodiment of the labeling machine in the invention, the labeling machine further includes an image capturing device which is disposed on the substrate, and used for capturing images of the object, so as to adjust the position and the orientation of the labeling machine.

In one embodiment of the labeling machine in the invention, the labeling machine further includes a printing module which is disposed on the substrate and adjacent to the carrying shaft.

In one embodiment of the labeling machine in the invention, the labeling machine further includes a pressing unit which is disposed on the substrate and located above the peeling unit, wherein a flat surface of the pressing unit is parallel to the peeling unit, and the pressing unit includes: a top plate; a pressing plate which has a plurality of holes and disposed under the top plate; a plurality of steel balls which are located between the top plate and the pressing plate, placed in the holes, and exposed by the holes; and a plurality of springs which are disposed between the steel balls and the top plate, wherein the label on the labeling base passing between the pressing unit and the peeling unit is pressed uniformly via an elastic restoring force of the spring.

In one embodiment of the labeling machine in the invention, the labeling machine further includes a sensor which is disposed beside the pressing unit, wherein the sensor is adapted to detect a height of at least one of the steel balls, so as to confirm a thickness of the label. The sensor passes through the top plate and detects the height of at least one of the steel balls based on a space from the pressing plate to the peeling unit; or the sensor detects the height of the label based on the distance from the pressing plate to the peeling unit.

In one embodiment of the labeling machine in the invention, the labeling machine further includes a casing which is disposed on the second surface of the substrate to cover the second surface, wherein the furling shaft is not disposed on the second surface. The casing includes a main case and a sliding cover, and the sliding cover has an opening, wherein the sliding cover is still fixed on the second surface when the main case is disassembled from the second surface.

In one embodiment of the labeling machine in the invention, the labeling machine further includes a diameter sensor which is disposed beside the furling shaft, wherein the diameter sensor comprises a plurality of sensing units, the sensing units are arranged symmetrically, and a center of symmetry of the diameter sensor offsets relative to an axis of the furling shaft.

Based on the above, the labeling machine in the invention is assembled at a robot to perform the labeling action automatically via the assembling member. In addition, the configuration structure of the labeling machine in the invention is newly designed and different from the configuration structure of the conventional labeling machine. Therefore, a compact configuration structure can be achieved, and the volume of the labeling machine is effectively reduced. In addition, the accuracy when the label is attached is increased via the shifting device.

In order to make the aforementioned and other features and advantages of the invention more comprehensible, embodiments accompanying figures are described in detail belows.

### BRIEF DESCRIPTION OF THE DRAWINGS

FIG. 1A is a schematic view of a labeling machine according to an embodiment of the invention.

FIG. 1B is a schematic view of the labeling machine in FIG. 1A having an assembly member.

FIG. 2 is a right side view of FIG. 1A.

FIG. 3 is a left side view of FIG. 1A.

FIG. 4 is a schematic top view of the labeling machine in FIG. 1A.

FIG. 5A and FIG. 5B are schematic diagrams at different angles of an assembly of a first base, a second base, and two adjusting members.

FIG. 6, FIG. 7A, FIG. 7B, ˜FIG. 9 are schematic diagrams of a labeling paper at a peeling unit gradually detaching from a label base and being used to label by a labeling head of a labeling unit.

FIG. 10 is a schematic view of the labeling machine pressing and sticking a label on the object.

FIG. 11˜FIG. 14 are schematic diagrams of a labeling machine configured with a blowing member.

FIG. 15 is a schematic view of a labeling machine integrated with a printing device.

FIG. 16˜FIG. 19 are schematic view of a labeling machine according to another embodiment.

FIG. 20A is a schematic view of a labeling machine according to the second embodiment of the invention.

FIG. 20B is an exploded view of FIG. 20A.

FIG. 21 is a schematic view at a different angle of the labeling machine in FIG. 20A.

FIG. 22 is a right side view of FIG. 21.

FIG. 23A and FIG. 23B are schematic diagrams of the pressing unit and the sensor disposed at different positions.

FIG. 24 is a front side view of FIG. 21.

### DESCRIPTION OF THE EMBODIMENTS

The invention is described comprehensively hereinafter with reference to the accompanying drawings, in which the embodiments of the invention are shown. The invention may be embodied in many different forms and should not be construed as limited to the embodiments set forth herein. Rather, these embodiments are provided so that this disclosure will be thorough and complete, and will fully convey the scope of the invention to related professionals with common knowledge skilled in the art. In the drawings, the thicknesses of layers and regions may be exaggerated for clarity. In addition, because of numerous elements, some elements mentioned in one paragraph are not necessary indicated or described in said paragraph and the reference drawings of said paragraph. People skilled in the art should find the corresponding elements and element numbers in other paragraphs and figures in the present application.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. In the figures, the same element numerals are used to indicate the same elements. As used herein the term “and/or” includes any and all combinations of one or more of the associated listed items. Other words used to describe the relationship between elements or layers should be interpreted in a like fashion (e.g. “between” versus “directly between,” “adjacent” versus “directly adjacent,” “above” versus “directly above,” etc.).

It will be understood that, the terms “first,” “second,” etc., may be used herein to describe various elements, components, or members, these elements, components, or members should not be limited by these terms. These terms are only used to distinguish one element, component, or member from another element, component, or member. Thus, a first element, component, or member discussed below could be termed a second element, component, or member without detaching from the teachings of the embodiments.

Spatially relative terms, such as “beneath”, “below”, “lower”, “under”, “above,” “upper,” “over” and the like, may be used herein for ease of description to describe one element or structural feature's relationship to another element(s) or structural feature(s) as illustrated in the drawings. It will be understood that the spatially relative terms are intended to encompass different orientations of the device in use or operation in addition to the orientation depicted in the drawings. For example, if the device in the drawings is turned over, elements described as “below” or “beneath” or “under” other elements or structural features would then be oriented “above” or “over” the other elements or structural features. Thus, the exemplary terms “below” and “under” describes a concept of relative position that depends on the relative position between an element and the base point, and the spatially relative descriptors used herein are interpreted accordingly.

Except that other annotation and description are added, the meanings of all of the terms (including technical and scientific terms) in the technical field of embodiments of the invention are the same as the common knowledge to the person skill in the art. It will be further understood that the meanings of the terms defined in an universal dictionary are the same as the meanings of the terms in prior art, and the terms should not be idealized or over-formalized except that it is clearly defined in the present application.

### The First Embodiment

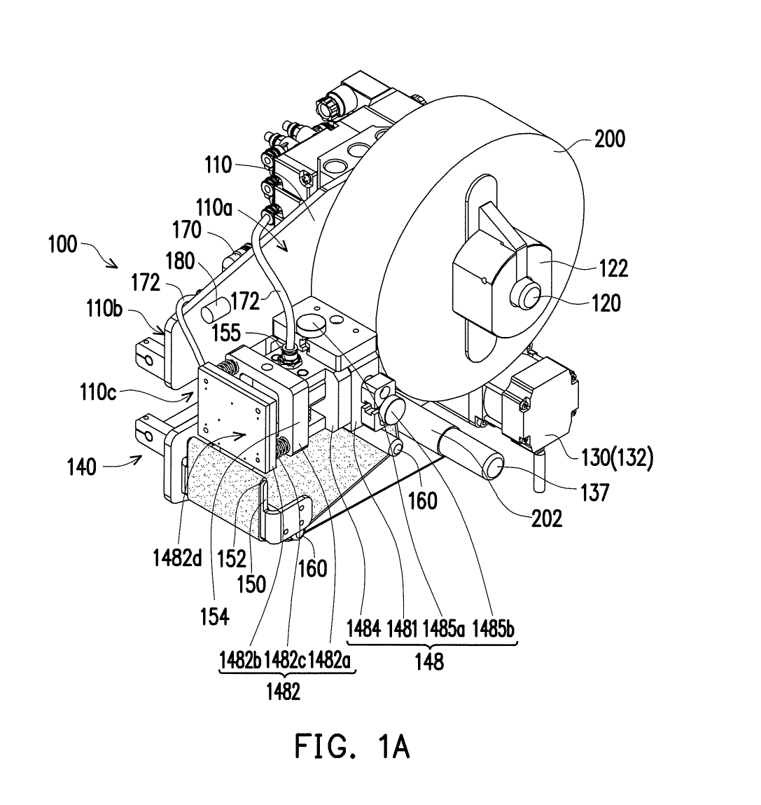

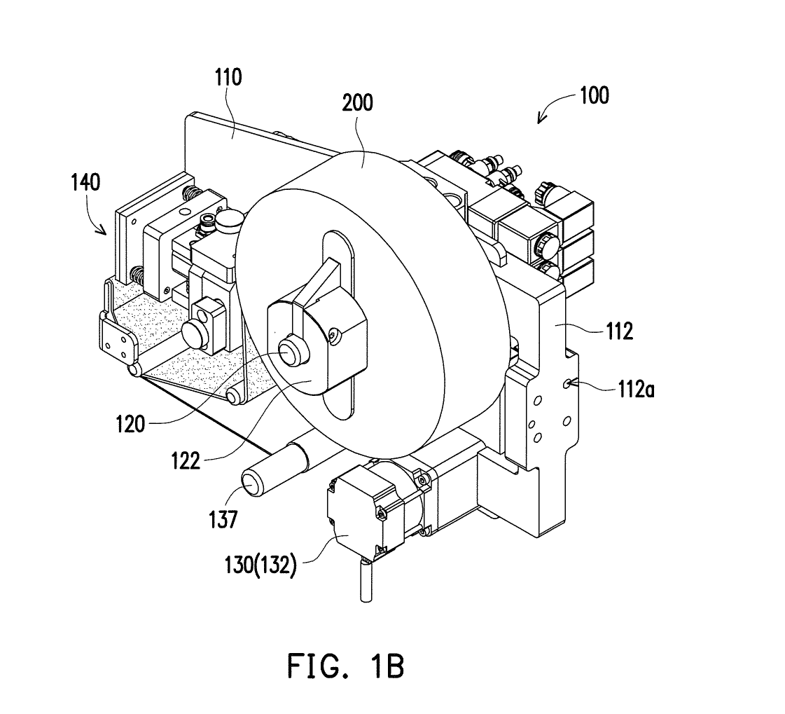

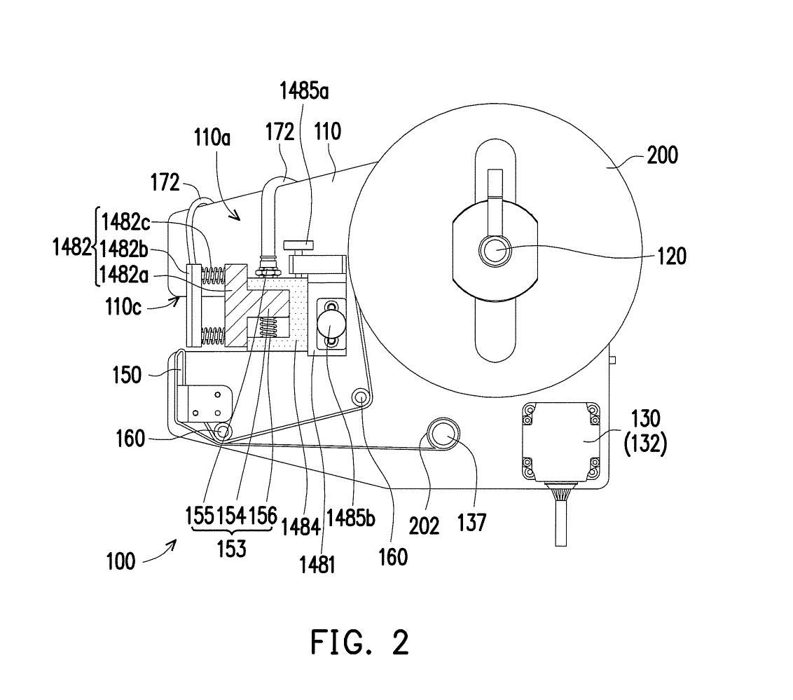

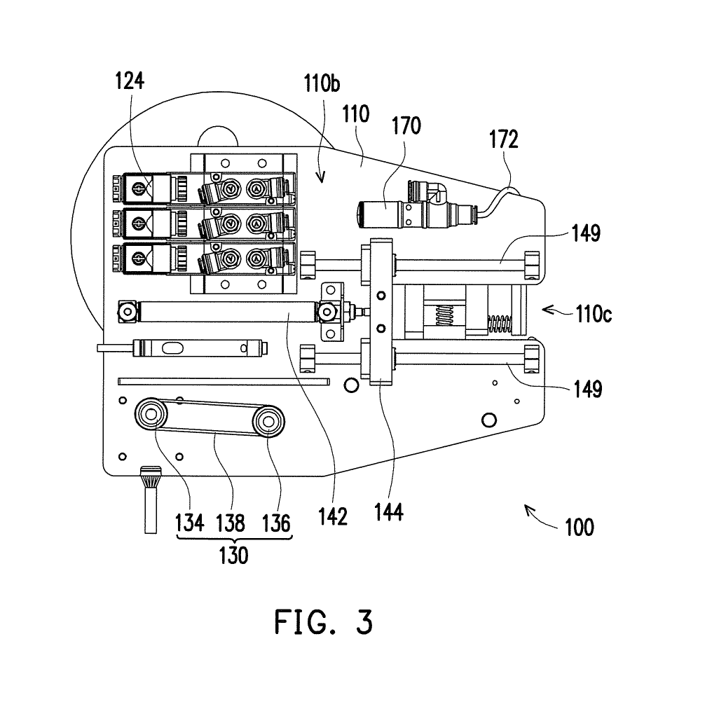

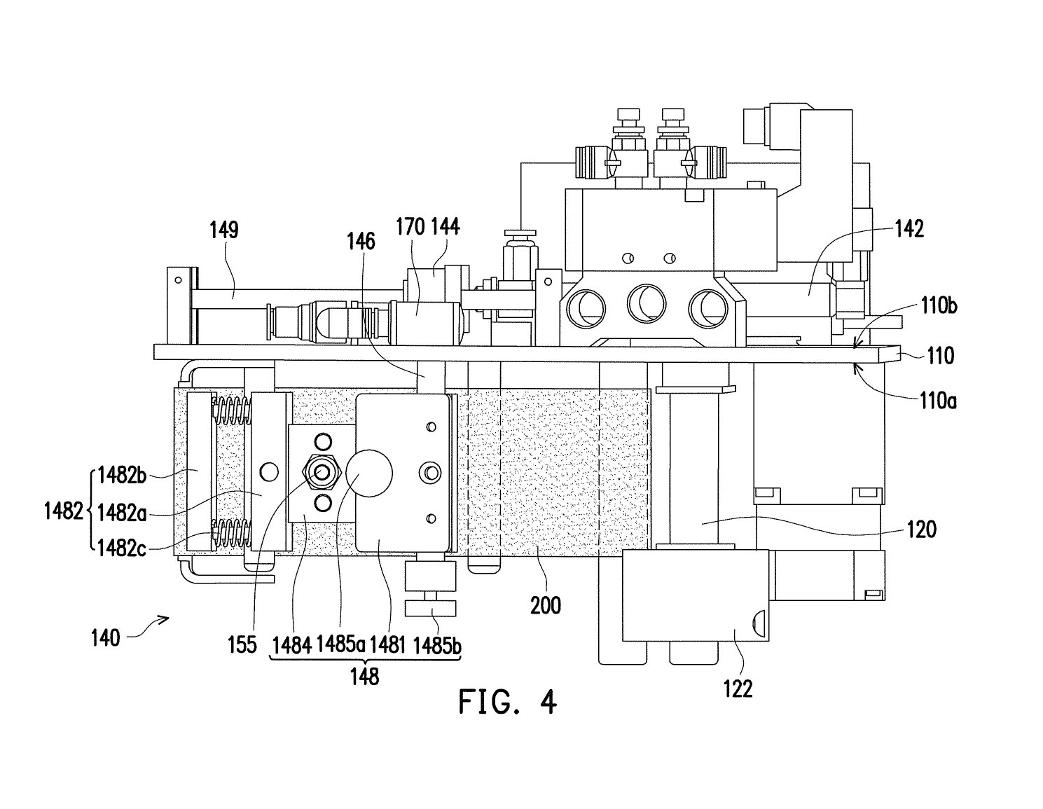

FIG. 1A is a schematic view at a specific angle of a labeling machine according to the first embodiment of the invention, FIG. 1B is a back side view of FIG. 1A, FIG. 2 is a right side view of FIG. 1A, and FIG. 3 is a left side view of FIG. 1A. Referencing FIG. 1A, FIG. 1B, FIG. 2, and FIG. 3, a labeling machine 100 includes a substrate 110, an assembling element 112, a carrying shaft 120, a driving module 130, a labeling module 140, and a peeling unit 150. Wherein, the substrate 110 is a metal plate or a composite plate with sufficient loading strength to support the various assembled elements or components on it. Furthermore, the substrate 110 can be mounted by using the assembling element 112 onto other moving devices capable of fixating the labeling machine 100, such as a multi-axis articulated robot, a multi-axis parallel robot, and a single axis or multi-axis linear robot, etc. The side of the substrate 110 by which a labeling action takes place is defined as the front side, and the opposite end to where a labeling action take place is defined as the back side. The assembling element 112 can be installed at the back side of the labeling machine 100 as an assembly interface to a robot (not shown), as shown in FIG. 1B. For example, the assembling element 112 can have a plurality of assembling structures 112a, which can be assembly holes, such that the substrate 110 can easily assemble to the locking interfaces (not shown) of many types of robots. Surely the assembling element 112 can also be assembled onto a robot via structure coordination. The assembly member 112 structure details and its relative position to the substrate 110 can be decided according to requirements and are not limited by these embodiments described in the present specification. In addition, the method used in the assembling structure, such as the locking screws can also be selected based on requirements, and to situate matching assembly holes in accordance to the locking interface design of the robot.

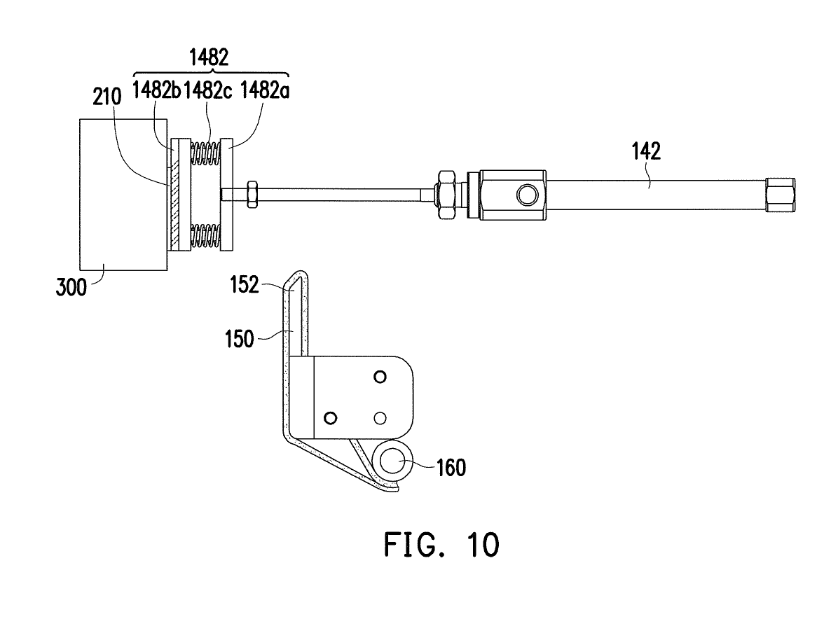

Referencing FIG. 1A, FIG. 2, and FIG. 3, the carrying shaft 120, the driving module 130, and the labeling module 140 all are disposed on the substrate 110, and the carrying shaft 120 is located on a first surface 110a of the substrate 110 thus allowing a roll of label base 200 to dispose onto the carrying shaft 120, and one end 202 of the label base 200 is wound around a furling shaft 137. Wherein, the furling shaft 137 on the first surface 110a is connected to the rotating shaft 136 of the driving module 130 penetrated through the substrate 110, and the motor 132 disposed on the first surface 110a is connected to a rotating shaft 134 disposed on the second surface 110b. Therefore, when the motor 132 operates, the rotating shaft 134 rotate and drive the rotating shaft 136 to rotate via a belt 138 which wreathe around the rotating shafts 134, 136. Hence, the roll of label base 200 is pulled by the furling shaft 137 directly driven via the rotating shaft 136, and when each sheet of the label 210 originally adhered on the label base 200 (as shown in FIG. 6) gradually detaches from the label base 200 when passing through a pressing unit 150, the labeling module 140 would acquire the label 210 and adheres the label 210 onto the object 300 (as shown in FIG. 10). It should be noted that, before the action that the label 210 is peeled from the label base 200, all these labels 210 are roughly placed with equal gaps on the label base 200. After the peeling action on the label 210, the label base 200 no longer retains this label 210 thereon. The action of peeling the label 210 is described later in this application.

In the present embodiment, the peeling unit 150 is disposed beside the labeling module 140; or more precisely, when the labeling module 140 does not perform labeling action, the peeling unit 150 is located under the labeling module 140, and the peeling unit 150 is located at the front side of the substrate 110 compared to the carrying shaft 120 (in comparison with the peeling unit 150, the carrying shaft 120 is located at the back side of the substrate 110). Here the concept of “front” and “back” is defined depending on the labeling action of the labeling module 140, where the labeling module 140 moves forward to be closer to the object 300 (as depicted in FIG. 10) and when the labeling module 140 adhere the label 210 onto the object 300 and the direction of it returning to the original position is moving backward. The front edge 152 of the peeling unit 150 in the present embodiment is an inclined plane or an arc surface, and upwardly inclined in a direction further away from the carrying shaft 120 to close to the carrying shaft 120, so that the label 210 detaches easily from the label base 200 when the label base 200 passes by the peeling unit 150.

More specifically, the driving module 130 includes a motor 132, rotating shafts 134, 136, and a belt 138. The motor 132 is disposed on the first surface 110a, and the rotating shafts 134, 136 are disposed on a second surface 110b of the substrate 110, wherein the rotating shaft 134 is connected to the motor 132, and the belt 138 wreathe around both rotating shafts 134, 136, so that the motor 132 directly drives the rotating shaft 134 to rotate the rotating shaft 136. Therefore, the furling shaft 137 is subsequently driven to furl the label base 200 (as shown in FIG. 2) having peeled labels 210 (as shown in FIG. 6). Because the rotating shafts 134, 136 are disposed on the second surface 110b of the substrate 110, the number of elements configured on the first surface 110a of the substrate 110 can be reduced providing more space to adjust the locations of the elements which need to be disposed on the first surface 110a. In another embodiment, the motor 132 can be disposed on the second surface 110b, and the shaft of the motor 132 can directly drive the furling shaft 137 to rotate, so that there is no need for installations of the rotating shaft 134, the rotating shaft 136, and the belt 138.

FIG. 4 is a schematic top view of the labeling machine in FIG. 1A, wherein some elements are omitted in order to explain clearly. Referencing FIG. 1A, FIG. 3, and FIG. 4, the labeling module 140 is located beside the carrying shaft 120, and the labeling module 140 in the present embodiment includes a cylinder 142, a positioning block 144, a driving rod 146, and a labeling unit 148. The cylinder 142 and the positioning block 144 are all disposed on the second surface 110b, and the cylinder 142 and the positioning block 144 are connected to each other. Therefore, the positioning block 144 is driven by the cylinder 142 and can operate along a straight line on the second surface 110b. The driving rod 146 is fixed to the positioning block 144 and passes through the substrate 110 to connect with the labeling unit 148. Furthermore, the labeling unit 148 fixed to the driving rod 146 can move along with the movement of the positioning block 144 shifted by the cylinder 142. The cylinder 142 needs to be connected to an external pneumatic pressure source 124. Since the operation and principle of the cylinder 142 should be common knowledge to the person skilled in the art, the details will not be described herein.

The substrate 110 can have a breach 110c, and the driving rod 146 passes through the breach 110c, so as to be connected with the labeling unit 148 on the other side of the substrate 110; in other words, the axial direction of the driving rod 146 is perpendicular to the direction of movement of the positioning block 144. Therefore, the driving rod 146 is accommodated in the breach 110c and can be moved within the breach 110c. Incidentally, in order to clarify between the breach 110c and the labeling head 1482, the number of the breach 110c is pointed to a side wall of the breach 110c in FIG. 2.

The labeling module 140 can further include a pair of tracks 149, and the tracks 149 are disposed along two opposite sides of the breach 110c on the substrate 110. More specifically, the tracks 149 can be formed by a pair of rods installing on the second surface 110b, and the rods pass through the positioning block 144. Therefore, when the positioning block 144 is actuated by the cylinder 142 to operate, the positioning block 144 can move in a smooth straight line because of the rods.

The labeling unit 148 includes a first base 1481, a second base 1484, and a labeling head 1482. The first base 1481 is disposed on the first surface 110a of the substrate 110, connected to the driving rod 146, and moves along with the movement of the driving rod 146. The second base 1484 fits in with the first base 1481, the second base 1484 has a top portion 1484a and a bottom portion 1484b, and there is a space between the top portion 1484a and the bottom portion 1484b. In addition, the labeling head 1482 leans against the front end of the second base 1484, and connects to the shifting device 153. Because of the shifting device 153, the labeling unit 148 can moves back and forth in a direction facing towards the bottom of the substrate 110. Structure details and actuation method of the shifting device 153 are described as followings. In the present embodiment, the labeling head 1482 includes an abutting block 1482a which leans against the second base 1484 and connects to the shifting device 153, a labeling block 1482b which is located in front of the abutting block 1482a, and an elastic member 1482c which connects the abutting block 1482a and the labeling block 1482b. The abutting block 1482a and the pressing block 154 can be integrated to become one body or fitted in with each other by structural fitting method, and the elastic member 1482c can be a spring, a block of foam, or other objects which have elastic deformation ability. The deformation ability of the elastic member 1482c can provide buffering effect when the label is adhered on the object 300 (as shown in FIG. 10) by the labeling unit 148, so that the force of the labeling unit 148 is uniformly applied on the object 300, and the label can be adhered firmly on the object 300 (as shown in FIG. 10).

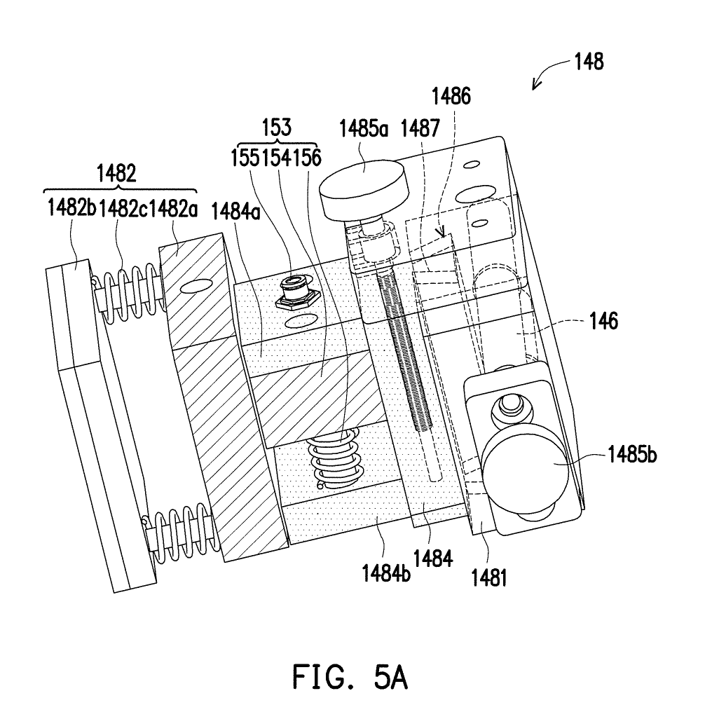

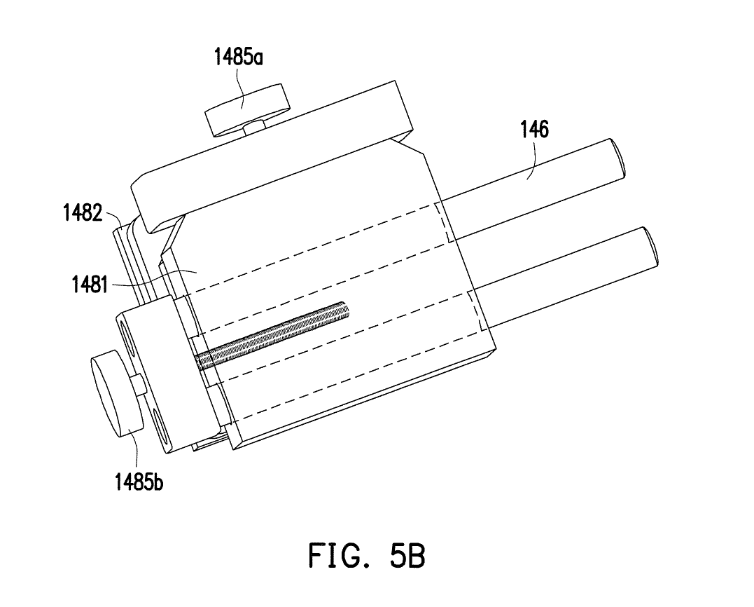

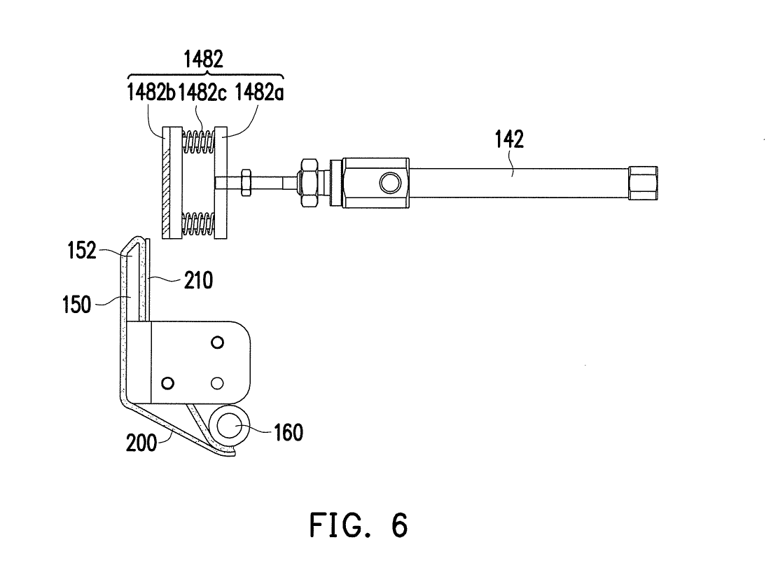

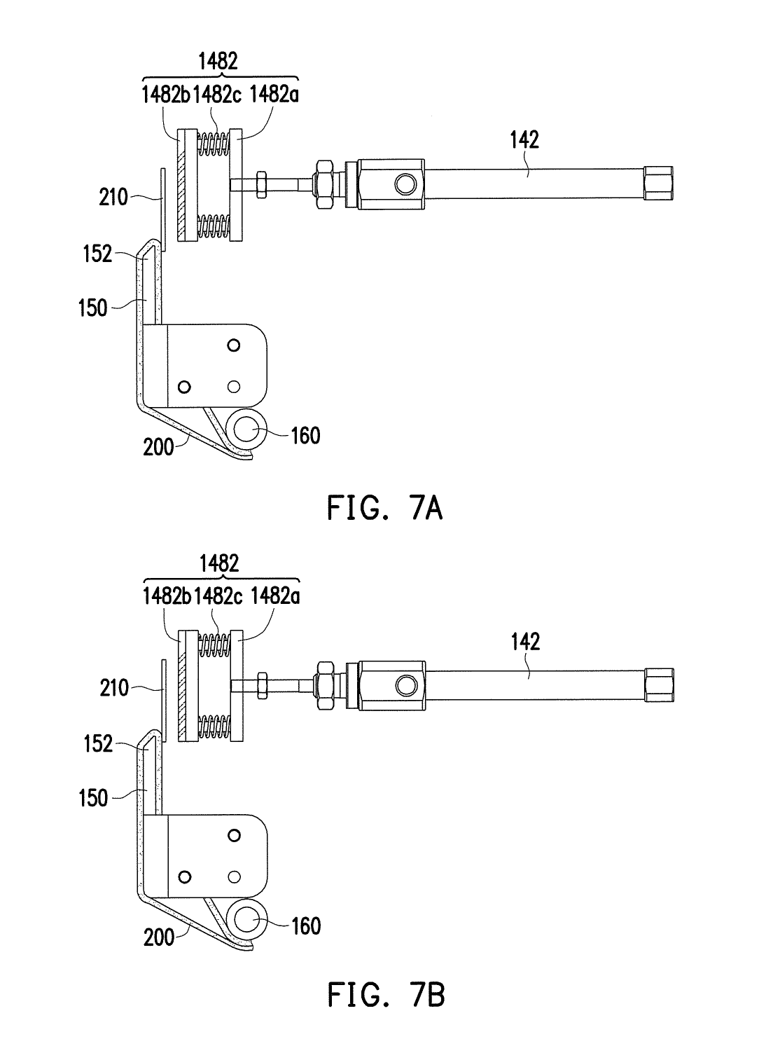

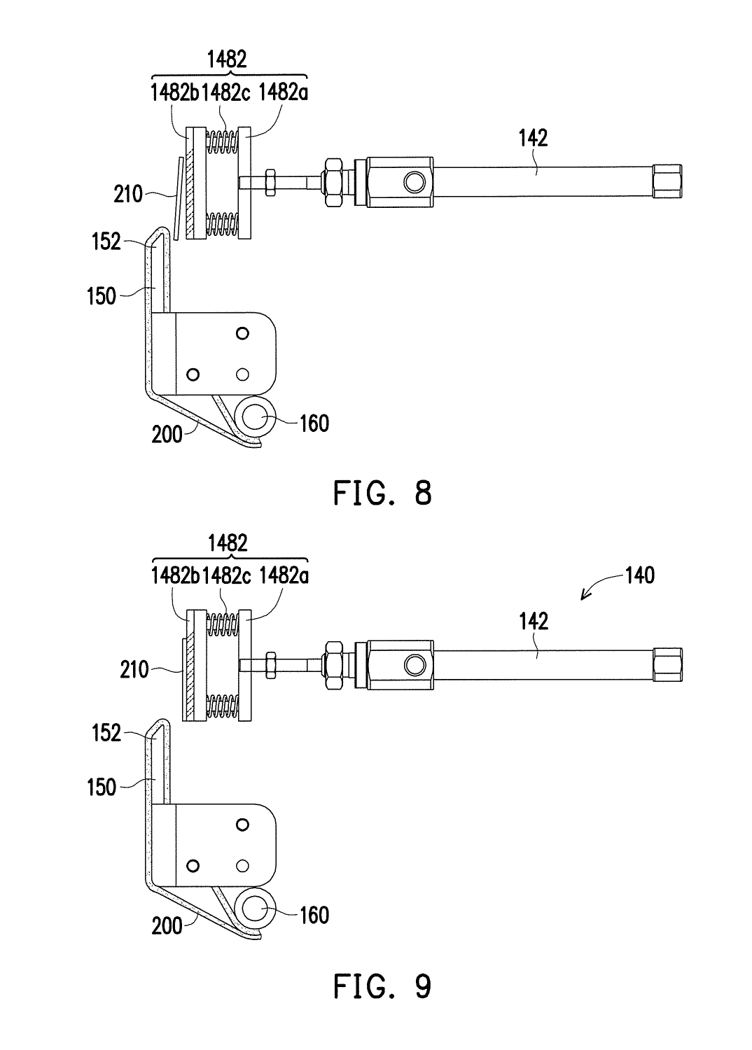

FIG. 5A and FIG. 5B are schematic diagrams at different angles of an assembly of a first base, a second base, and two adjusting member. Referencing FIG. 5A and FIG. 5B, the first base 1481 can have an extended part, the labeling unit 148 (as shown in FIG. 1A) further includes a pair of adjusting members 1485a, 1485b, wherein the adjusting member 1485a passes through the extended part of the first base 1481 and inserts into the second base 1484. Therefore, the second base 1484 moves relatively to the first base 1481 via the adjusting member 1485a, and the direction of movement of the second base 1484 is perpendicular to the direction of movement of the first base 1481 (referring to FIG. 2, the second base 1484 moves up and down, and the first base 1481 is driven by the driving rod 146 to move to the left and to the right). In the present embodiment, the direction of movement of the first base 1481 is driven by the driving rod 146, the direction of movement of the second base 1484, and the axial direction of the driving rod 146 are mutually perpendicular to each other.

The installation of the adjusting member 1485b makes the first base 1481, which is bored by the driving rod 146, adjustable, so as to change the position of the first base 1481 on the driving rod 146. Therefore, the labeling head 1482 can move closer to or away from the substrate 110 via adjusting the adjusting member 1485b. To be simplified, the first base 1481 can moved axially on the driving rod 146 by adjusting the member 1485b.

Incidentally, the first base 1481 can have a trapezoidal shaped notch 1486, and the second base 1484 can have a bump 1487 corresponding to the shape and size of the notch 1486. In addition, because the bump 1487 and the notch 1486 are interlocked, the second base 1484 and the first base 1481 are limited to moving relatively along the longitudinal direction of the notch 1486, and there is no need to have other additional condition for components for preventing the second base 1484 from rotating relatively to the first base 1481 or moving relatively to the notch 1486 in a non-longitudinal direction. The shapes of the bump 1487 and the notch 1486 are not limited to that shown in the present embodiment, and can be changed according to the actual design requirements. In addition, there are other methods to achieve the same goal of limiting the second base 1484 and the first base 1481 to move in a fixed direction relatively.

FIG. 6˜FIG. 9 are schematic diagrams of a labels at a peeling unit gradually detaching from the label base 200 and captured by the labeling head 1482 of the labeling unit 148. Wherein, only cylinder 142 and labeling unit 148 are described for the purpose of clarity. People skilled in the art without departing or violating the installation purpose of the driving module 130 and the labeling module 140 can change the selected elements or their relative configurations and operating relationships used in the driving module 130 and the labeling module 140 according to the actual requirements and are not limited to the embodiments in this application. In addition, the aforementioned driving module 130 and the labeling module 140 can be individually driven by separate circuits.

Referencing FIG. 1A, FIG. 2, FIG. 3, and FIG. 6, when the labeling machine 100 is used, firstly, a roll of label base 200 is first disposed onto the carrying shaft 120, wherein the labels 210 are roughly placed with equal gaps on the label base 200. In order to prevent the label base 200 from falling out of the carrying shaft 120 due to inertia while the label base 200 is driven to rotate, the label base 200 can be restricted to stay on the carrying shaft 120 by a cover 122 fixed at an end relatively far away from the substrate 110.

The end 202 of the labeling base 200 is fixed onto the furling shaft 137 after wrapping around the peeling unit 150. When the motor 132 operates, the rotating shaft 134 directly connected to the motor 132 would rotate, so as to drive the other rotating shaft 136 to rotate synchronously via a belt 138. In addition, the furling shaft 137, which is located on the first surface 110a and is coaxially connected to the rotating shaft 136 on the second surface 110b, rotates and retrieve the aforementioned labeling base 200, so as to deliver the labeling paper 210. In order to prevent the label base 200 from being interfered by other elements on the substrate 110, a position limiting member 160, such as a position limiting rod, can be disposed at an appropriate position on the substrate 110. Therefore, the label base 200 bypasses the position limiting member 160 and the peeling unit 150, and finally wind around the furling shaft 137. Optionally, the label base 200 can also be guided along a designed path to deliver the label 210 by setting up a track restraining method. It should be noted that the end 202 of the label base 200 is wound around and fixed to the furling shaft 137 in order to provide tension on the label base 200, so that the label 210 is easily stripped from the label base 200 and the label base 200 is easily collected after the label 210 is removed. In practice, the end 202 of the label base 200 can also not be wound around the furling shaft 137 to facilitate automatic winding, but through other automation structure designs to collect the label base.

Referencing FIG. 6, FIG. 7A, and FIG. 7B, under the condition that the labeling base 200 is driven to move forward continuously, because the front edge 152 of the peeling unit 150 is an inclined plane or an arc surface, the label base 200 is pulled backwards at a turning point of the peeling unit 150 to move in the reverse direction by rotation of the furling shaft 137, the label 210 is not pulled back together with the label base 200 but rather the label 210 is continued to move forward (moving up) and departs gradually from the labeling base 200 as it is wounded.

Referencing FIG. 1A, FIG. 2, FIG. 5A, FIG. 7A, and FIG. 7B, a shifting device 153 is further disposed on the second base 1484, the shifting device 153 includes a pneumatic cylinder 155, a pressing block 154, and an elastic member 156. The pneumatic cylinder 155 is disposed on the second base 1484 and is connected to a solenoid valve which is disposed on the second surface 110a of the substrate 110 via a connecting pipe 172. In addition, the high-pressure gas inside the cylinder 142 enters the pneumatic cylinder 155 via a circuit controlling the solenoid valve, so that the pneumatic cylinder 155 applies a force on the pressing block 154, which is located between the top portion 1484a and the bottom portion 1484b of the second base 1484, in the downward direction. Therefore, the pressing block 154 departs from the top portion 1484a of the second base 1484 and moves towards and closely to a bottom portion 1484b of the second base 1484, so as to compress the elastic member 156 which is, for example, a compressed spring. The downward movement of the pressing block 154 drives the labeling head 1482 to move downwardly, so that the label 210 is completely located inside the internal part of the labeling block 1482b of the labeling head 1482.

To be more specific, the labeling head 1482 and the peeling unit 150 are typically positioned close to each other and kept at a very small space in between, so that the labeling head 1482 which is sucking the label 210 does not touch the peeling unit 150 while moving forward. As a result, when the label 210 is sucked by the labeling head 1482, while most of the label 210 is sucked onto the labeling head 1482, a small part of the label 210 still sticks on the label base 200 is kept outside the labeling head 1482. Therefore, when the labeling head 1482 pushes forward to complete the action of adhering the label 210, the portion of the label 210 outside of the labeling block 1482b of the labeling head 1482 is impacted and separated away from the peeling unit 150, and when the labeling head 1482 touches an object, the exposed portion of the label 210 does not achieve good adhesive effect without the applying pressure from the rear labeling head 1482. The role of the traverser is using the air pressure to overcome the elastic force of the elastic member 156 disposed between the pressing block 154 and the bottom portion 1484b of the second base 1484, pushing the labeling head 1482 downward towards the bottom of Figure to move closer to the peeling unit 150, the area of the labeling head 1482 may slightly overlapped with the peeling unit 150 (or even completely overlapped with the peeling unit 150, according to actual design requirements). Therefore, the labeling head 1482 can reach the rear of the whole sheet of the label 210, so that the label 210 is completely placed within the area of the labeling head 1482. After the labeling head 1482 sucks the label 210 using vacuum force, the pressure source of the cylinder 142 is closed, the labeling head 1482 is pushed to return to the original position without overlapping with the peeling unit 150 by the elastic restoring force of an elastic member 156, such as a compressed spring, which is disposed between the bottom portion 1484a of the second base 1484 and the pressing block 154. At this moment, the whole sheet of the label 210 is completely sucked and held at the front of the labeling head 1482 (as shown in FIG. 9), when the labeling head 1482 is pushed forward to perform sticking action, the whole sheet of the label 210 can receive sustained applying pressure from the labeling head 1482 after touching the object, so as to complete the adhesive action effectively.

Referencing FIG. 1A, FIG. 5A, and FIG. 7B, specifically, the height, which is relative to the front edge 152 of the peeling unit 150, of the labeling head 1482 can be readjusted manually via the adjusting member 1485a that passes through the extended part of the first base 1481 and inserts into the second base 1484, so that the label 210 can completely and accurately locate within the area of the labeling head 1482, so as to prevent the possibility of exposing an edge of the label 210 outside the labeling head 1482. Even though the adjusting members 1485a, 1485b in the present embodiment are screws, it is not limited to in this invention and can be substituted with suitable components according to actual requirements.

Referencing FIG. 3 and FIG. 8, the labeling machine 100 further includes a vacuum generator 170 which is disposed on the second surface 110b, the surface of the labeling block 1482b of the labeling head 1482 has openings 1482d, and the connecting pipe 172 connects the vacuum generator 170 to the openings 1482d on the labeling block 1482b. When the label 210 detaches gradually from the label base 200, the vacuum generator 170 is generating suction, and the label 210, which detaches gradually from the label base 200, is sucked and attached to the labeling head 1482 by suction method, so that the label 210 is easily obtained by the labeling head 1482. After that, the labeling module 140 is moved upwards, thus ensuring the labeling head 1482 to not interfere with the peeling unit 150 while it moving forward, as shown in FIG. 9.

FIG. 10 is a schematic diagram of the labeling machine applying a label onto the object 300. Referencing FIG. 10, the cylinder 142 actuates to move the labeling head 1482 of the labeling module 140 forward, and as the labeling head 1482 is held against the object 300 through the continuous applying pressure from the cylinder 142, the elastic deformation of the elastic member 1482c disposed between the abutting block 1482a and the labeling block 1482b, is able to buffer the force continuously provided by the cylinder 142, so as to prevent an excessive force applying on the object 300 (as shown in FIG. 10).

Furthermore, an image capturing device 180 (as shown in FIG. 1A) can be disposed on the first surface 110a of the substrate 110, the image capturing device 180 can be a camera allowing the labeling machine 100 to be remotely controlled to perform the labeling action. The camera is used to capture images including that of the object 300, transmitted to the operator, so that the position and the orientation of the labeling machine 100 can be remotely controlled according to the contents of the images captured by the image capturing device 180, and the labeling head 1482 can be controlled to reach the position facing the object 300, so as to stick the labeling paper 210 at an accurate position. If the labeling machine 100 is installed onto a robot, the image capturing device 180 can be used to serve as a vision source to perform vision-based robot control (Visual Servoing). The position and the orientation of the robot end-effector can be automatically controlled to precisely move the labeling head 1482 of the labeling machine 100 to the front of the object 300 utilizing the rendered image data of the object 300 from the image capturing device 180, and so to perform the labeling action. Utilizing the image capturing device 180 and the vision-based visual servoing technique, a robot installed with this labeling machine 100 can automatically find the object 300 and execute labeling application. This fully automatic labeling method can save the time and cost to preciously allocate labeling objects to a selected location, and an implemented application of intelligent automation.

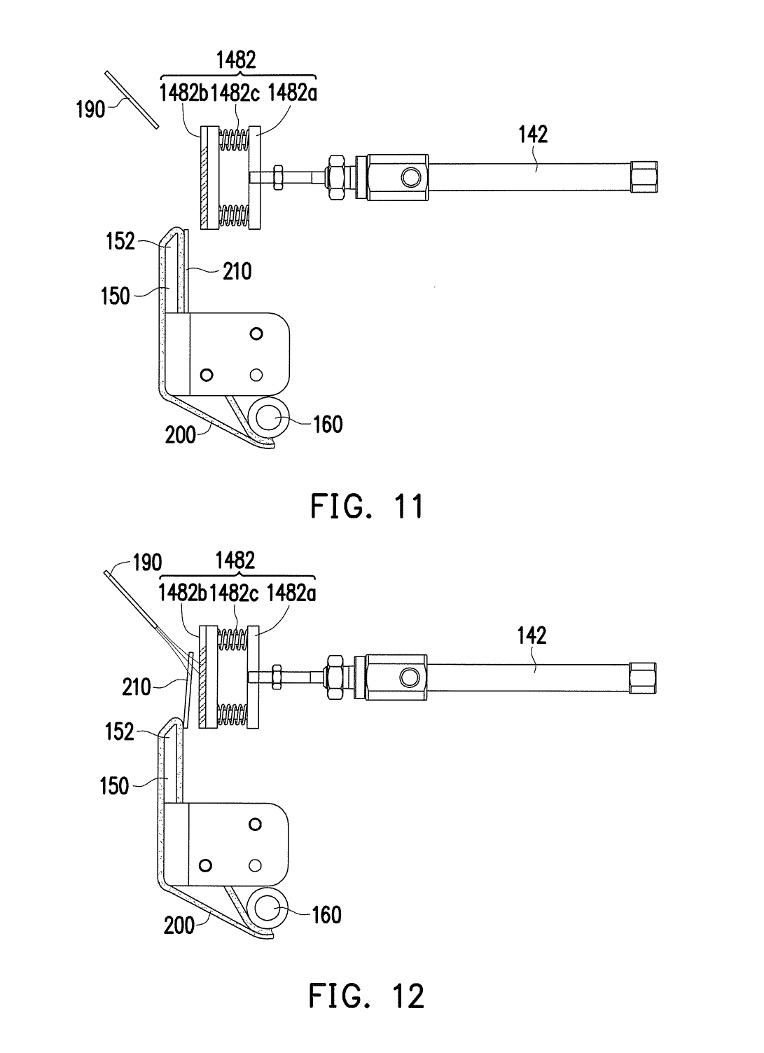

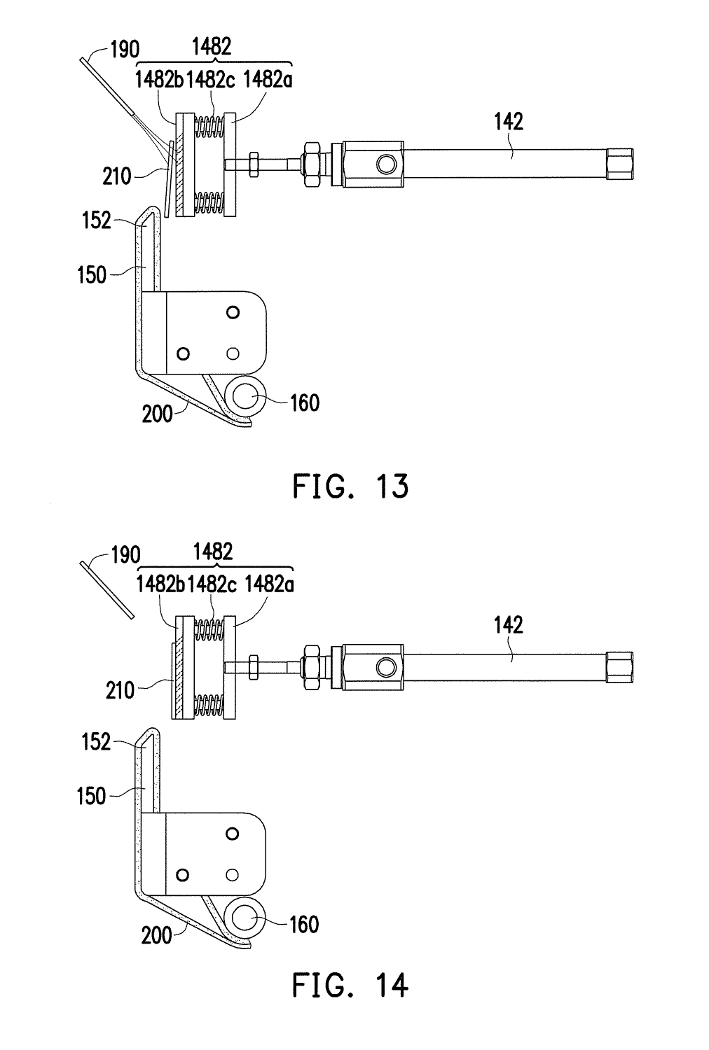

FIG. 11˜FIG. 14 are schematic diagrams of a labeling machine configured with a blowing member. Referencing FIG. 11 to FIG. 14 sequentially, the labeling machine 100 in the present embodiment can include a blowing member 190 which is disposed corresponding to the labeling module 140 (as shown in FIG. 1A) and the peeling unit 150, the blowing member 190 can be independently disposed outside the substrate 110 or can also be an integrated element to the substrate 110, such as a blowing pipe.

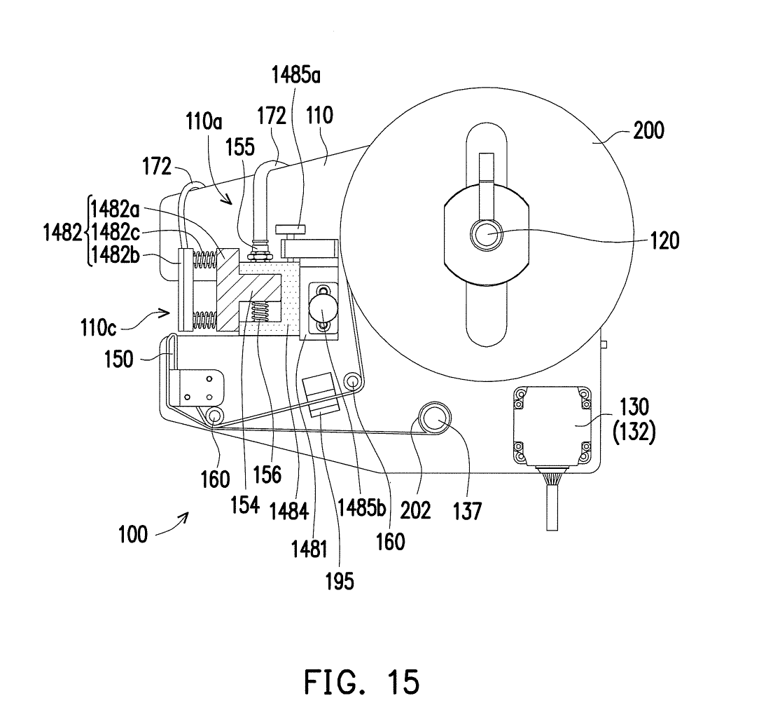

Referencing FIG. 15, a printing module 195 is further disposed between the two position limiting members 160 which is on the first surface 110a of the substrate 110 of labeling machine 100, the printing module 195 can perform printing instantly on the label 210, and apply the printed label 210 to the object 300 at a specific time. Because a small printing device is of a conventional technology, it will not be described herein.

### The Second Embodiment

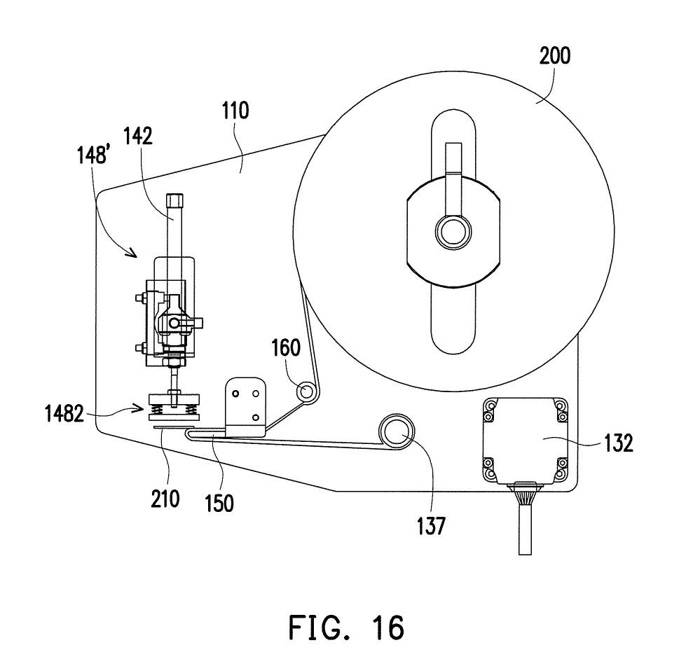

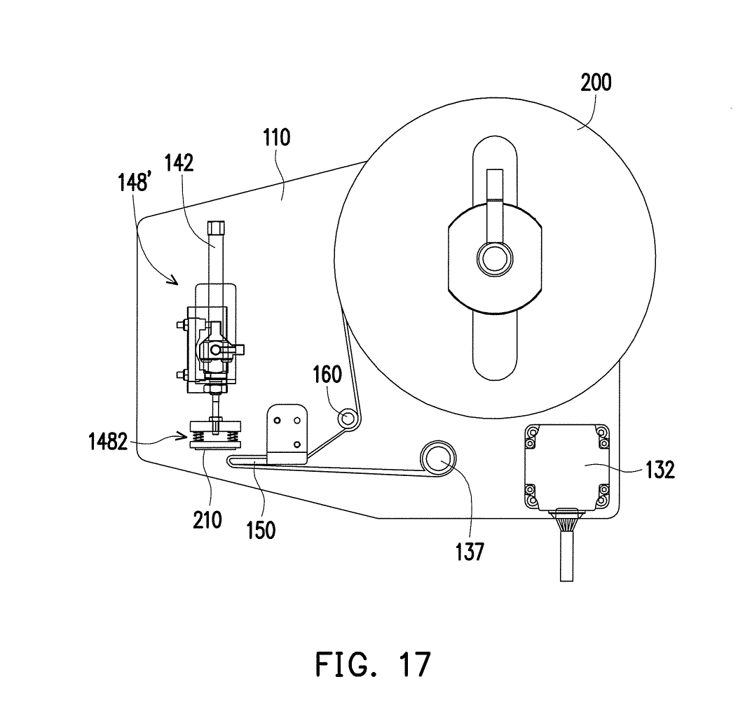

FIG. 16˜FIG. 19 are schematic diagrams of a labeling machine according to the second embodiment in the invention. Referencing FIG. 16˜FIG. 19, in the present embodiment, the peeling unit 150 is disposed on the side of the bottom end of the substrate 110, and the labeling unit 148′ is disposed on the substrate 110 by pivoting method. After the labeling head 1482 of the labeling unit 148′ obtains the label 210, the labeling unit 148′ can rotate approximately 90 degree on the first surface 110a, and then the step that the label 210 is adhered on the object 300 is performed by the actuation of the cylinder 142. The positions of the elements are appropriately designed, so that the cylinder 142 and the rotation of the labeling unit 148′ are not interfered with other elements, and the cylinder 142 and the labeling unit 148′ can be disposed on the same side of the substrate 110. However, the cylinder 142 and the labeling unit 148′ can be disposed on different sides of the substrate 110 because of other considerations, such as miniaturizing the volume of the whole labeling machine. Otherwise, the cylinder 142 and the labeling unit 148′ can be disposed whether to operate together or not, for example, after the labeling unit 148′ rotates to reach to a certain position, the labeling action is performed via the thrust of the cylinder 142. Incidentally, the labeling machine in the present embodiment further includes the shifting device 153 (as shown in FIG. 2), wherein the shifting device 153 pushes the labeling unit 148′, so that an overlapping area of the labeling head 1482 and the peeling unit 150 is formed.

The installation and operation of other elements of the labeling machine in the present embodiment is similar to the installation and operation of the above-mentioned embodiment, and therefore the description about installation and operation are omitted.

### The Third Embodiment

The present embodiment is substantially the same as the first and the second embodiment; the same or the similar reference number presents the same of the similar element, only the difference is described as following. Simply speaking, the configuration of the modules, elements or components of the present embodiment is different from the first embodiment. That is, the modules, elements or components are disposed at different positions on the substrate. Because the differences in position of the modules, elements or components, some of the elements are not required and can be omitted. Although there are differences in configuration, the actuation of the labeling machine 100′ of the present embodiment is similar to the actuation of the labeling machine 100 of the first embodiment. Therefore, the description of the similar actuation is not repeated.

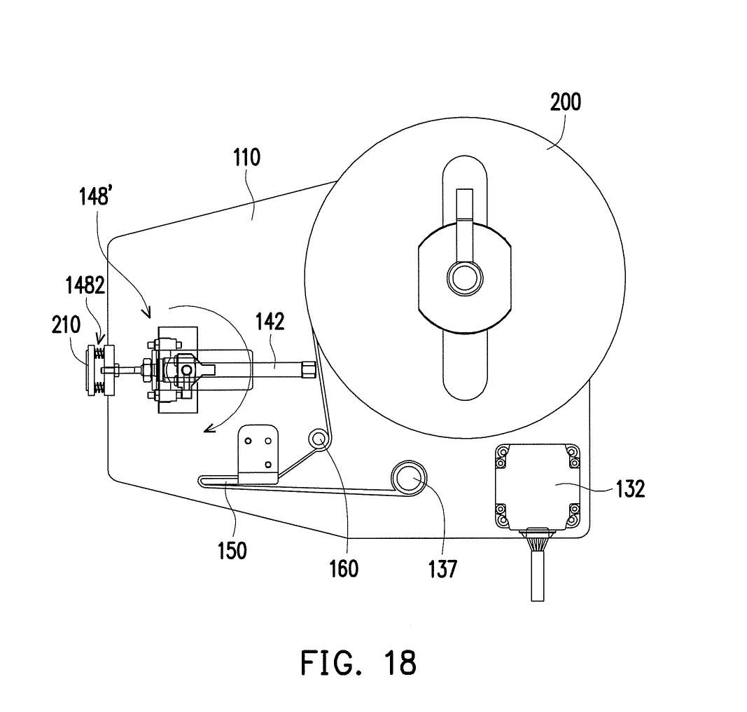

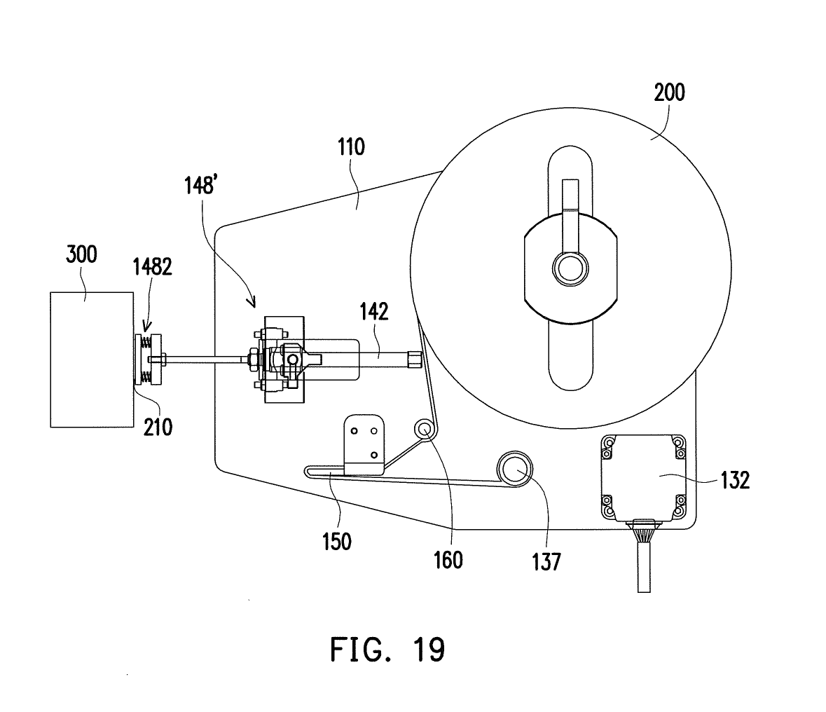

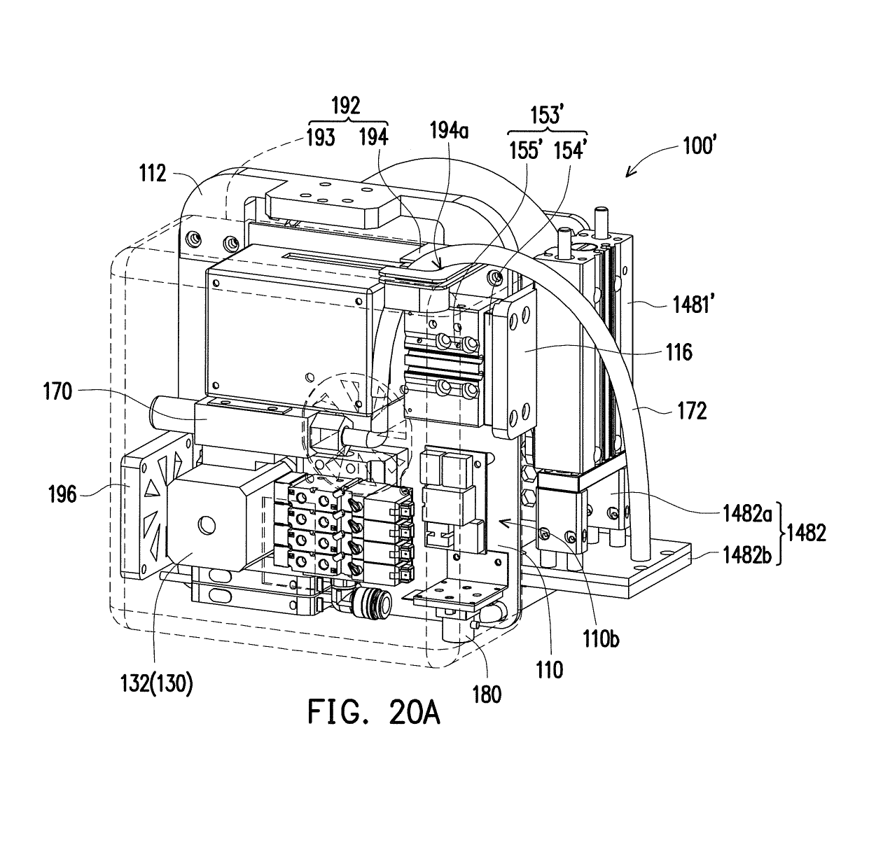

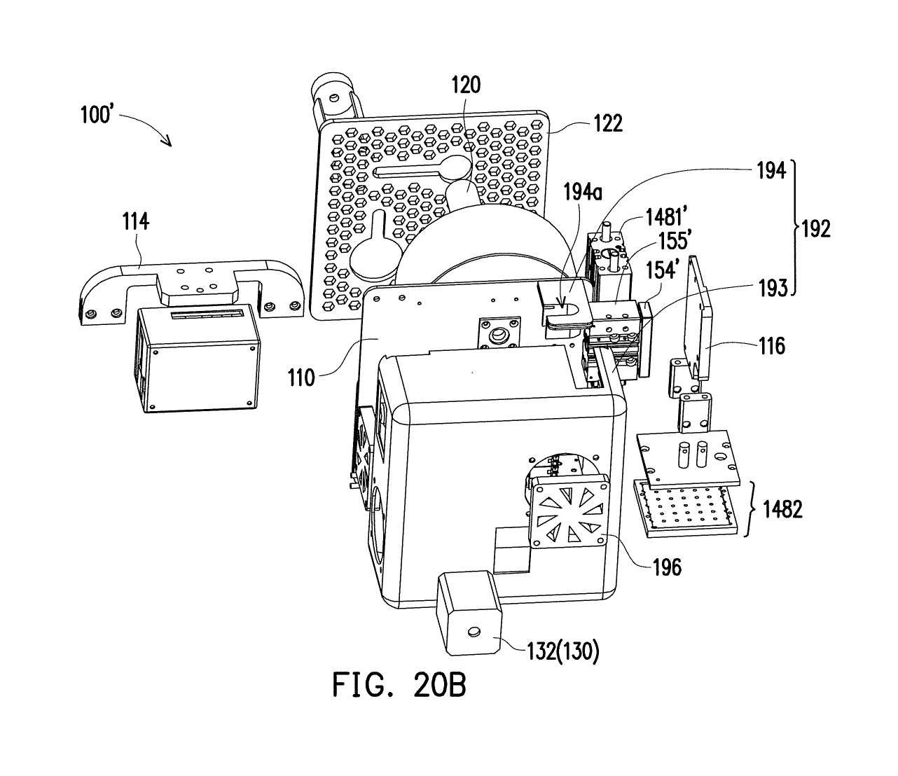

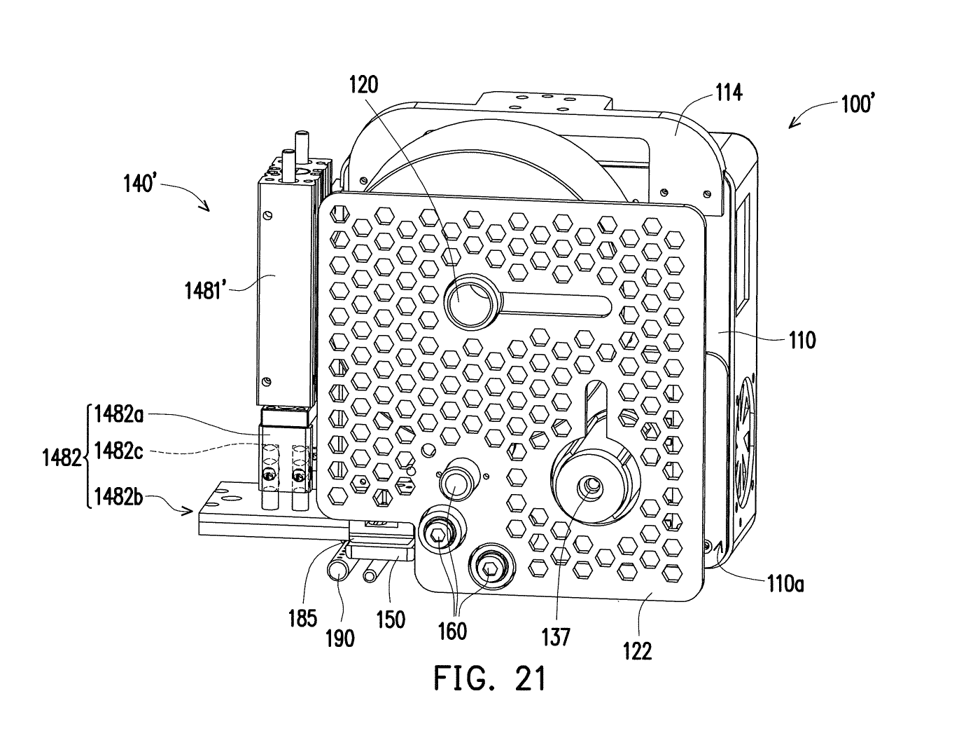

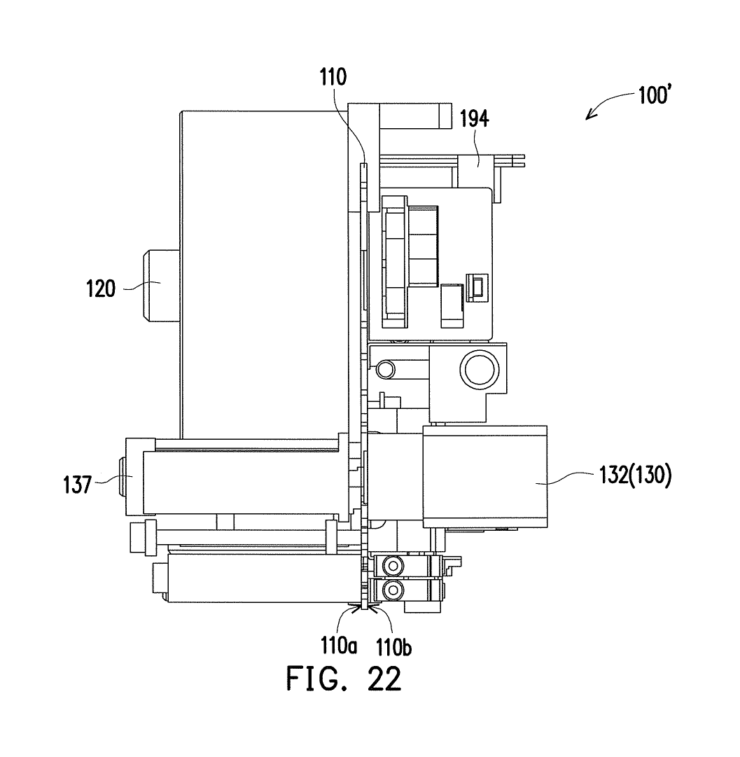

FIG. 20A is a schematic view of a labeling machine according to the third embodiment of the invention and FIG. 20B is an exploded view of FIG. 20A. FIG. 21 is a schematic view at a different angle of the labeling machine in FIG. 20A. FIG. 22 is a right side view of FIG. 21; some elements in FIG. 22 are omitted in order to make the drawing clear and easier to understand.

Referencing FIG. 20A, FIG. 21, and FIG. 22, the driving module 130 includes the motor 132 which is disposed on the second surface 110b of the substrate 110, and the motor 132 passes through the substrate 110 and directly connects to the furling shaft 137 which is disposed on the first surface 110a. Therefore, the belt 138 (shown in FIG. 3) is not required in the present embodiment compared to the first embodiment. Additionally, a motor (not shown) can be further disposed corresponding to and connected to the carrying shaft 120. Therefore, the motor connected to the carrying shaft 120 and the motor 132 connected to the furling shaft 137 can be driven simultaneously via a control system (not shown), so that the furling shaft 137 and the carrying shaft 120 can rotate synchronously. This dual-motor design provides sufficient torque to overcome the resistance which happens when the label base 200 is retrieved.

Again, Referencing FIG. 1A and FIG. 21. The cover 122 of the first embodiment is manufactured as a cap (a shown in FIG. 1A), whereas the cover 122 of the present embodiment is manufactured as a plate, and the rods 120, 137, 160 on the first surface 110a can be sleeved simultaneously by the cover 122 which has a plate shape. A lot of holes can be made in the cover 122 (as shown in FIG. 21) in order to reduce the total weight of the labeling machine 100.

In addition, the labeling module 140′ of the present embodiment is different from the labeling module 140 of the above-mentioned embodiments. As shown in FIGS. 6˜14, the peeling unit 150 of the first embodiment is disposed in the vertical direction, and the corresponding labeling module 140 is disposed on the substrate 110 and moves leftwards to perform the labeling action. Referencing FIG. 20A, the peeling unit 150 of the present embodiment is disposed in the horizontal direction, and the labeling module 140′ is disposed beside the substrate 110 and moves downwards to perform the labeling action. To be more specific, the labeling module 140 in the above-mentioned embodiments include the cylinder 142 which is disposed on the substrate 110, the positioning block 144, the driving rod 146, and the labeling unit 148, 148′ which includes the first base 1481, the second base 1484, and the labeling head 1482, etc., so that the structure is complex and most of space on the substrate 110 is occupied.

In contrast, the labeling module 140′ in the present embodiment is disposed beside the substrate 110, and an overlapping area of the labeling module 140′ and the peeling unit 150 can be formed via the shifting device 153′. The devices capable of capturing the label 210 (as indicated in FIG. 6) can be completely located inside of the region of the labeling block 1482b of the labeling head 1482. Therefore, there are more spaces on the substrate 110. More specifically, the shifting device 153′ in the present embodiment includes a pressing block 154′ and a cylinder 155′, and the labeling module 140′ is fixed to the pressing block 154′ and located on the side edge of the substrate 110. The difference from the above-mentioned embodiment is that the cylinder 155′ of the present embodiment is directly used to control the pressing block 154′ to move back and forth, and the elastic member 156 (as shown in FIG. 5A) is omitted.

Moreover, another difference between the above mentioned embodiments and the present embodiments is that the labeling module 140′ of the present embodiment includes a positioning block 116, a first base 1481′, and a labeling head 1482, wherein the second base 1484 is omitted. The positioning block 116 is fixed to the cylinder 155′ and located on a side edge of the substrate 110 via the pressing block 154′; the first base 1481′ is directly replaced by the cylinder, and the labeling head 1482 is connected to the first base 1481′. The similarity to the above-mentioned embodiment is that the labeling head 1482 of the present embodiment also includes the labeling block 1482b, the elastic member 1482c, and the abutting block 1482a, wherein the abutting block 1482a is connected to the first base 1481′, which is a cylinder; the elastic member 1482c is installed in the abutting block 1482a and buffers the force that is continuously applied by the first base 1481′ (which is a cylinder) when the cylinder 155′ drives the labeling head 1482 to adhere the label 210 (as shown in FIG. 10) onto the object 300 (as shown in FIG. 10). Comparing to the complex structure of the labeling unit 148 and 148′, such structure in the above-mentioned embodiments (such as the positioning block 144, the driving rod 146, the first base 1481, the second base 1484, the adjusting member 1485a, 1485b, the pneumatic cylinder 155, etc., as shown in FIG. 3) is replaced by the cylinder in the labeling module 140′ of the present embodiment. Therefore, the present embodiment includes less types and fewer number of elements compared to the above-mentioned embodiments, ultimately reduces the friction between elements when moving. In addition, the labeling head 1482 can provide a uniform force to adhere the label 210 onto the object 300 (as shown in FIG. 10). Incidentally, for appearance and durability of the labeling machine 100′, other structures (such as a rectangular casing, not shown) can be used to enclose the elastic member 1482c, while maintaining the elastic deformation of the elastic member 1482c to buffer the force that is provided by the first base 1481′, so as to prevent an excessive force applying on the object 300 (as shown in FIG. 10) when the label 210 is adhered.

In particular, because of the shifting device 153′, the cylinder 155′ can be driven to actuate and then to drive the labeling module 140′, which is disposed on the pressing block 154′ via the positioning block 116, to reach the inner boundary of the peeling unit 150 (at least one part of the labeling block 1482b overlaps with the peeling unit 150), so that the label 210 is captured (as shown in FIG. 6) and moved to the labeling position, and then the first base 1481′, which is a cylinder, drives the labeling head 1482, which is disposed in front of the first base 1481′, to perform the labeling action.

Incidentally, because the peeling unit 150 is disposed in the horizontal direction and the labeling module 140′ is disposed beside the substrate 110 and moves downwards to perform the labeling action, the blowing member 190 which as a tubular shape can be disposed in front of the peeling unit 150 (as shown in FIG. 21). As a result, the blowing member 190 is closer to the label 210 and is in a better position to blow the label 210 compared to the above-mentioned embodiments, so as to assist the labeling head 1482 to capture the label 210 accurately.

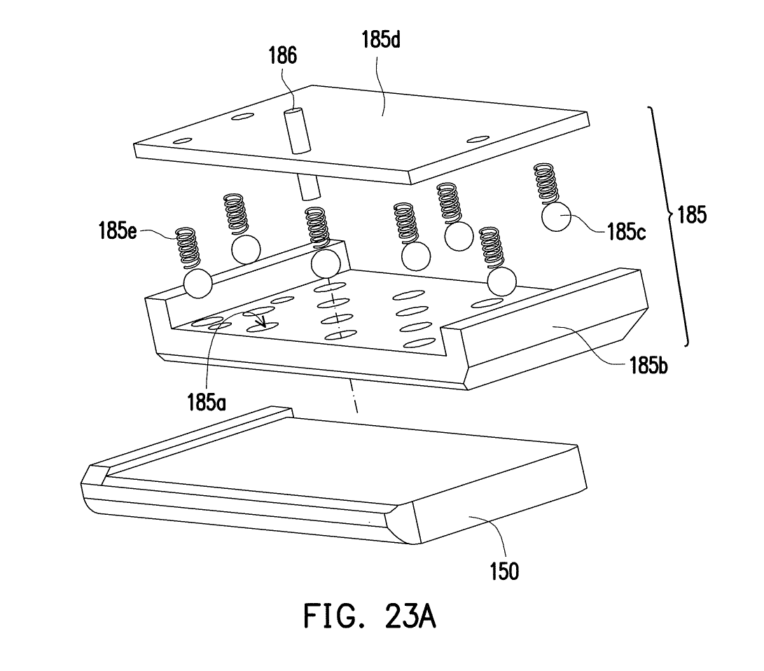

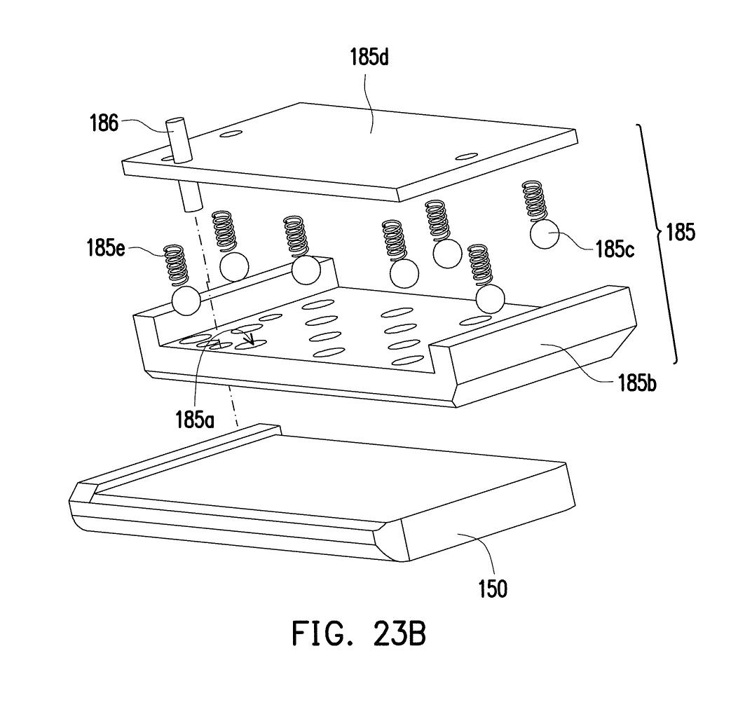

FIG. 23A is schematic view of the pressing unit and the sensor. Referencing FIG. 21 and FIG. 23, the labeling machine 100′ of the present embodiment further includes a pressing unit 185, and the pressing unit 185 is also disposed on the first surface 110a of the substrate 110 and located above the peeling unit 150. The pressing unit 185 includes a pressing plate 185b which has a plurality of holes 185a, a plurality of steel balls 185c which are placed in the holes 185a, and a plurality of elastic members 185e which are disposed between the steel balls 185c and a top plate 185d. The steel balls 185c located between the top plate 185d and the pressing plate 185b are pressed by the elastic members 185e and exposed by the holes 185a. The pressing unit 185 is used to provide sufficient positive pressure via the elastic member 185e and the steel ball 185c, for the label 210 (as indicated in FIG. 10) and label base 200 (as indicated in FIG. 1A), which passes through between the pressing unit 185 and the peeling unit, while reducing friction when the label 210 on the label base 200 is moving horizontally. There are reserved headroom between the top plate 185d and the pressing plate 185b to buffer the vertical position differences when the steel balls 185c move upward upon receiving the push from the label 210 because of the height variance between the label base 200 and the label 210 pressing plate.

In addition, a sensor 186 is further disposed at the pressing unit 185, the sensor 186 passes through the top plate 185d and goes deeply into the space between the top plate 185d and the pressing plate 185b, and the sensor 186 is located upright and above the steel ball 185c, so as to detect the height of the steel ball 185c inside of the hole 185a. Because of the configuration of the steel ball 185c and the sensor 186, when the label base 200 (as shown in FIG. 6) is furled by the furling shaft 137 and the label base 200 passes through the pressing unit 185, the steel ball 185c has different heights corresponding to the labeling base 200 (as indicated in FIG. 6) only and the labeling base 200 (as indicated in FIG. 6) having the labels 210 (as indicated in FIG. 6) disposed on. Therefore, it is possible to detect whether the label 210 is on the label base 200 via the height of the steel ball 185c, and the position of the label 210 (as indicated in FIG. 6) on the label base 200 (as indicated in FIG. 6) passing by the peeling unit 150 is detected precisely. Simply speaking, because the labels 210 are substantially arranged and adhered with the same interval on the label base 200, the height of the steel ball 185c when the steel ball 185c presses on only the label base 200 is lower than the height of the steel ball 185c when the steel ball 185c touches on the label 210 on the label base 200 because the label 210 pushes the steel ball 185c up.

In the embodiment as shown in FIG. 23B, the sensor 186 passes through the top plate 185d and goes deeply into the space between the top plate 185d and the pressing plate 185b to detect directly the height of the label 210 below, so that the sensor 186 does not need to detect the height of the steel ball 185c. It should be noted that the most sensors 186 detect the height of the label 210 relatively to the surface of the label base 200 based on the optical principles may obtain an error because of the color and printing material at different parts of the surface of the label 210. Therefore, using the sensor 186 to sense the steel ball 185c instead of detecting the label 210 directly by the sensor can obtain more stable and accurate data.

Referencing the FIG. 20A again, the labeling machine 100′ further includes a casing 192 which is disposed on the second surface 110b of the substrate 110. In addition, the casing 192 is adapted to cover the second surface 110b and the elements which are disposed on the second surface 110b. The casing 192 can reduce dust accumulation and prevent the possibility that the human hands touch the elements disposed on the second surface 110b which are operating, so as to prevent the human hands from being injured. The casing 192 includes a main case 193 and a sliding cover 194 which can be separated from each other, wherein the sliding cover 194 has an opening 194a and a plurality of the connecting pipes 172 connecting to the cylinder 155′ and the first base 1481′, which is a cylinder, or the labeling block 1482b, or other electric wires go through the opening 194a, so as to be collected in the opening 194a. Incidentally, when the main case 193 is disassembled from the second surface 110b of the substrate 110, the sliding cover 194 is separated from the main case 193 and still fixed on the second surface 110b. Wherein, a hook, a compact structure, or other methods can be used to fix the sliding cover 194 to the second surface 110b, the sliding cover 194 is supported by the connecting pipe 172 or other wires that pass through the opening 194a from the bottom of the sliding cover 194, and the sliding cover 194 is held on the second surface 110b like a cantilever, so that the sliding cover 194 cannot fall from the substrate 110. Additionally, a fan 196 can be disposed on the main case 193 so that the heat dissipation efficiency inside of the casing 192 is increased by the fan 196.

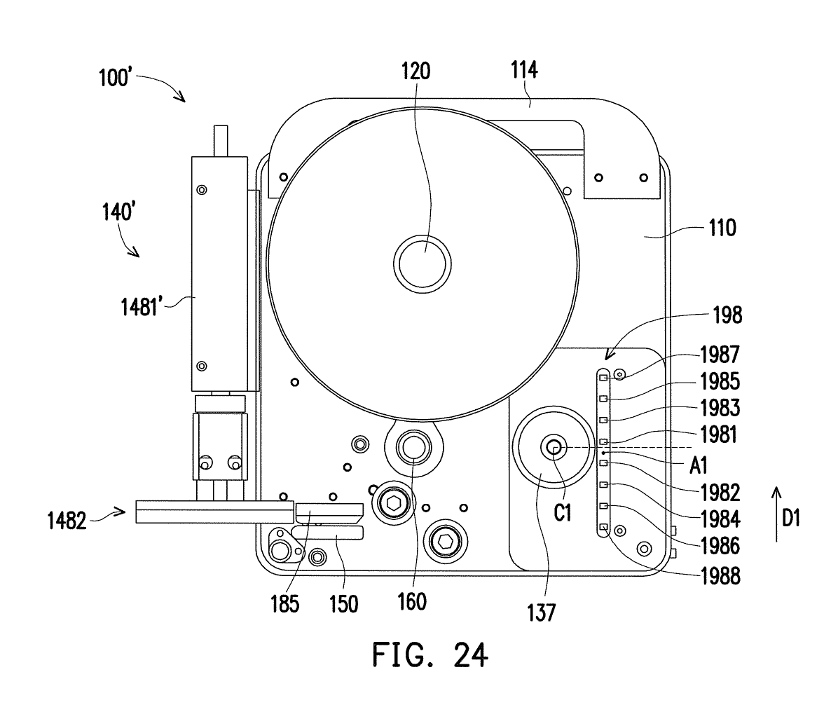

FIG. 24 is a front side view of FIG. 21, and the cover 122 is omitted to make to drawing clear. Referencing FIG. 21 and FIG. 24, a diameter sensor 198 is further disposed beside the furling shaft 137, the diameter sensor 198 includes 8 sensing units 1981˜1988, and the sensing units 1981˜1988 are, for example, arranged symmetrically. It should be noted that the sensing units 1981˜1988 do not sense the increment of the diameter of the labeling base 202 (shown in FIG. 1A) after being furled in pair although the sensing units 1981˜1988 is arranged symmetrically, sensing units 1981˜1988 sense sequentially.

To be more specific, the diameter sensor 198 in the present embodiment has a center of symmetry A1, and the center of symmetry A1 offsets an axis C1 of the furling shaft 137. As shown in FIG. 24, the center of symmetry A1 of the diameter sensor 198 and the axis C1 of the furling shaft 137 are not on the same horizontal line, and the center of symmetry A1 of the diameter sensor 198 is located lower (or higher) than the axis C1 of the furling shaft 137 in a D1 direction. In the present embodiment, along with the diameter increment of the label base 200 which is furled at the furling shaft 137, 8 sensing units 1981˜1988 sense the diameter variation of the end 202, which is furled, of the labeling base 200 one by one in sensing units 1981, 1982, 1983, 1984, 1985, 1986, 1987, 1988 sequence, so as to detect accurately the variation of the labeling base 200 furled on the furling shaft 137. The diameter of the label base 200 furling on the furling shaft 137 affects the length of retrieving label base when motor 132 rotates the furling shaft 137 a specific angle. Because the length of every label 210 is fixed, when the diameter of the label base 200 furling on the furling shaft 137 become larger, the motor 132 need to continue to reduce the angle of rotation, so as to achieve the mission that the label base 200 is retrieved at the same distance. The higher resolution of the diameter sensor 198, the higher precision the motor 132 can achieve. Because each of the sensing units 1981˜1988 has a certain volume, in order to prevent two of the sensing units 1981˜1988 from being collided to each other, the sensing units 1981˜1988 are sequentially staggered, so as to improve the resolution effectively.

Although 8 sensing units 1981˜1988 are described as an example in the present embodiment, the number of the sensing units are not limited thereto. After reading the specification of the invention, related professionals with common knowledge skilled in the art can alter the number of sensing units according to the actual requirements without violating and departing the spirit of the invention, and the sensing units can be further used in other field to sense the diameter variation of an object.

The invention is not limited to the three embodiments above. After reading the specification of the invention, related professionals with common knowledge skilled in the art can choose one of the module, element, or component, or combine some of the modules, elements, or components to use according to actual requirements. Without departing from the spirit of the invention and according to the content of the specification, the elements can be replaced by other element to achieve a similar effect.

In summary, the advantages of the labeling machine in the invention are at least listed as followings

1. The invention provides a labeling machine which has a different structure configuration from that of the conventional labeling machine. As a result, the labeling machine in the invention has a more compact structure and a smaller volume compared to the conventional labeling machine.
2. The labeling machine in the invention can combine the function of the peeling machine that the label is stripped off the label base and the action that the label is sucked and then adhered, so as to be appropriate to install at a robot to perform the automatic labeling action.
3. The position of the labeling head can be adjusted corresponding to the position that the labeling paper detaches gradually from the label base, so as to increase the alignment accuracy of the labeling head and the label paper.
4. In addition, because of the installation of the vacuum generator and the blowing member, the labeling paper can be held on the labeling head by suction method, or blowing method, or both suction and blowing method.
5. Because the center of symmetry of the diameter sensor and the axis of the furling shaft are not aligned, the sensing units can sense the diameter variation of the label base being furled from inside to outside sequentially and more precisely.
6. The pressing unit is correspondingly disposed above the peeling unit; when the label base on which the labels are adhered passes between the pressing unit and the peeling unit, a sufficient and positive pressure is provided for the label on the label base, and the friction is reduced when the label base with the labels thereon moves. In addition, the pressing unit uses the sensor to detect the height of the steel ball which is pressed onto one of the labels, so as to prevent the sensor from being affected by the printing surface of the labels, and to obtain more stable data.
7. The sliding cover of the casing can still be fixed to the substrate while the main case is disassembled from the substrate, while the connecting pipes or other wires are kept in the opening of the slide cover.
8. The casing can be manufactured as a plate, so as to limit the label base which passes by the rods, and to prevent the label base from moving.

It will be apparent to those skilled in the art that various modifications and variations can be made to the structure of the invention without detaching from the scope or spirit of the invention.

What is claimed is:

1. A labeling machine, comprising:
a substrate;
an assembling element, disposed at one side of the substrate for assembling the labeling machine onto a robot;
a carrying shaft, disposed on the substrate, wherein a label base on which a plurality of labels is attached is adapted to assemble on the carrying shaft;
a driving module, disposed on the substrate;
a labeling module, disposed on the substrate;
a peeling unit, disposed on the substrate, wherein the peeling unit is located beside a path on which the labeling module performs a removing label action; and
a furling shaft, disposed on the substrate, wherein the peeling unit, the carrying shaft and the furling shaft are all disposed at one side of the substrate and the label base is used to furl around the furling shaft which is controlled by the driving module,
wherein the label machine is assembled onto a robot by the assembling element, and while the label base passes by the peeling unit, the driving module drives the furling shaft to rotate, the label protruded from the label base is captured by the labeling module at adjacent region of the peeling unit.

2. The labeling machine as recited in claim 1, further comprising a shifting device, wherein the shifting device pushes the labeling module in a direction perpendicular to a label detaching direction of the labeling module, so as to generate an overlapping area of the labeling module and the peeling unit.

3. The labeling machine as recited in claim 2, wherein the shifting device comprises:
a pneumatic cylinder; and
a pressing block, connected with the pneumatic cylinder, wherein the pneumatic cylinder applies a force to push the pressing block and drives the labeling module to move, so that the overlapping area of the labeling module and the peeling unit is generated.

4. The labeling machine as recited in claim 3, wherein the shifting device further comprises a spring, the spring is disposed between the pressing block and the labeling module, and the spring is adapted to drive the pressing block back to an original position by an elastic restoring force when the pneumatic cylinder stops applying force.

5. The labeling machine as recited in claim 1, wherein the assembling element has a plurality of assembling structures, and the labeling machine and the robot are assembled together via the assembling structures.

6. The labeling machine as recited in claim 5, wherein the assembling structures can be assembly holes.

7. The labeling machine as recited in claim 1, wherein the driving module comprises:
a motor, disposed on a first surface of the substrate;
a pair of rotating shafts, disposed on a second surface of the substrate, wherein the first surface and the second surface are located at two opposite surfaces of the substrate, and one of the rotating shafts is connected with the motor, another one of the rotating shafts is connected with the furling shaft disposed on the second surface;
a belt, wreathing the rotating shafts, wherein the rotating shaft driven by the motor drives the rotating shaft connected with the furling shaft to rotate.

8. The labeling machine as recited in claim 1, wherein the driving module comprises:
a motor, disposed on the second surface of the substrate, and connected with the furling shaft disposed on the first surface of the substrate.

9. The labeling machine as recited in claim 1, wherein a front edge of the peeling unit is an inclined plane or an arc surface, and upwardly inclined in a direction from far from the carrying shaft to close to the carrying shaft.

10. The labeling machine as recited in claim 1, wherein the labeling module comprises:
a cylinder, disposed on a second surface of the substrate; and
a labeling unit, connected with the cylinder, and driven by the cylinder to operate along a straight line.

11. The labeling machine as recited in claim 10, wherein the labeling module further comprises:
a positioning block, connected to the cylinder, wherein the cylinder and the positioning block are disposed on the same side of the substrate, and the positioning block is driven by the cylinder to operate along a straight line;
a driving rod, fixed to the positioning block and passing though the substrate to connect with the labeling unit, wherein the driving rod drives the labeling unit to move along with a movement of the positioning block.

12. The labeling machine as recited in claim 11, wherein the labeling module further comprises a pair of tracks, disposed on the second surface and disposed along two opposite sides of a breach of the substrate, and the driving rod is moved within the breach.

13. The labeling machine as recited in claim 11, wherein the labeling unit comprises:
a first base, disposed on the first surface of the substrate, connected to the driving rod, and moved along with the movement of the driving rod;
a second base, fitting in with the first base, wherein the second base has a top portion and a bottom portion; and
a labeling head, leaning against a front end of the second base, and connecting to the shifting device,
wherein the shifting device actuates to drive the labeling head to move in a space between the top portion and the bottom portion of the second base, so as to generate an overlapping area of the labeling module and the peeling unit.

14. The labeling machine as recited in claim 13, wherein the labeling unit further comprises:
a pair of adjusting members, wherein one of the adjusting members passes through a part of the first base and inserts into the second base, the second base moves relatively to the first base via the adjusting member, a direction of movement of the second base is perpendicular to a direction of movement of the first base driven by the driving shaft, and another one of the adjusting members passes through the first base and adjusts a position of the first base on the driving rod relatively to a position of the substrate.

15. The labeling machine as recited in claim 13, wherein the labeling head comprises:
an abutting block, connecting to the shifting device and leaning against a front end of the second base;
a labeling block, located in front of the abutting block;
at least one pair of elastic members, disposed between the labeling block and the abutting block.

16. The labeling machine as recited in claim 1, wherein the labeling module is pivotally connected to the substrate and can rotate on the first surface.

17. The labeling machine as recited in claim 10, wherein the labeling module further comprises:
a positioning block, connected to the cylinder and located at a side edge of the substrate, wherein the positioning block is adapted to be driven by the cylinder to operate along a straight line;
a first base, fixed on the positioning block; and
a labeling head, disposed at a front end of the first base.

18. The labeling machine as recited in claim 17, wherein the labeling head comprises:
an abutting block, connected to the first base;
a labeling block, located in front of the abutting block; and
an elastic member, built into the abutting block, wherein the elastic member provides elasticity for the labeling block.

19. The labeling machine as recited in claim 1, further comprising a vacuum generator and a connecting pipe, wherein the vacuum generator is disposed on the substrate and connected to the labeling module by the connecting pipe to make the labeling module generate suction, so as to suck the label protruded from the labeling base.

20. The labeling machine as recited in claim 1, further comprising a blowing member, disposed corresponding to the labeling module and the peeling unit, wherein the blowing member blows the label protruded from the labeling base towards the labeling module.

21. The labeling machine as recited in claim 1, further comprising an image capturing device, disposed on the substrate, and used for capturing images of the object, so as to adjust the position and the orientation of the labeling machine.

22. The labeling machine as recited in claim 1, further comprising a printing module, disposed on the substrate and adjacent to the carrying shaft.

23. The labeling machine as recited in claim 1, further comprising a pressing unit, disposed on the substrate and located above the peeling unit, wherein a flat surface of the pressing unit is parallel to the peeling unit, and the pressing unit comprises:
a top plate;
a pressing plate, having a plurality of holes, disposed under the top plate;
a plurality of steel balls, located between the top plate and the pressing plate, placed in the holes, and exposed through the holes; and
a plurality of springs, disposed between the steel balls and the top plate, wherein the label on the labeling base passing between the pressing unit and the peeling unit is pressed uniformly via an elastic restoring force of the spring.

24. The labeling machine as recited in claim 23, further comprising a sensor, disposed beside the pressing unit, wherein the sensor is adapted to detect a height of at least one of the steel balls, so as to confirm a thickness of the label.

25. The labeling machine as recited in claim 24, wherein the sensor passes through the top plate and detects the height of at least one of the steel balls based on a space from the pressing plate to the peeling unit.

26. The labeling machine as recited in claim 24, wherein the sensor detects the height of the label within the space between the pressing plate and the peeling unit.

27. The labeling machine as recited in claim 1, further comprising a casing, disposed on the second surface of the substrate to cover the second surface, wherein the furling shaft is not disposed on the second surface.

28. The labeling machine as recited in claim 27, wherein the casing comprises a main case and a sliding cover, and the sliding cover has an opening,
wherein the sliding cover is still fixed on the second surface when the main case is disassembled from the second surface.

29. The labeling machine as recited in claim 1, further comprising a diameter sensor, disposed beside the furling shaft, wherein the diameter sensor comprises a plurality of sensing units which are arranged symmetrically, and the center of symmetry of the diameter sensor is offset from the axis of the furling shaft.
